(19) United States
(12) Patent Application Publication
(10) Pub. No.: US 2009/0240442 A1
(43) Pub. Date: Sep. 24, 2009

(54) Method of manufacturing and testing solid dosage products, and apparatus for the testing

(76) Inventor: William Zeng, Indianapolis, IN (US)

Correspondence Address: WILLIAM B. ZENG, P.O. BOX 269035, INDIANAPOLIS, IN, 46226-9035, UNITED STATES, 317-377-0589, 317-377-0589

(21) Appl. No.: 12/214,909

(22) Filed: Jun. 24, 2008

Related U.S. Application Data
(60) Provisional application No. 60/937,755, filed on Jun. 29, 2007.

(51) Int. Cl. G06F 19/00

(52) U.S. Cl. 702/23

(57) ABSTRACT

A method of manufacturing and a method of testing a solid dosage product each include a step of determining and evaluating at least one property of dissolution of an ingredient of a sample of the solid dosage product, each of the at least one property being in an advantageous form and/or determined and evaluated in an advantageous manner, e.g., as a function of cumulative mass of the ingredient dissolved from the solid dosage product. A dissolution testing cell for determining a said at least one property of dissolution includes a cell cavity and at least one side opening thereto, each in a shape or form, and in a spatial relationship one to another, advantageously adapted to facilitate the determining and the evaluating. A dissolution testing apparatus includes first and second pump means, at least first switching valve means, a cumulative vessel, sampling means, and control means, each advantageously adapted and arranged one in relation to another for determining pair-wise value of a said at least one property and value of cumulative mass of the ingredient dissolved, and, in certain embodiments of the apparatus, means for manipulating vertical orientation of the cell cavity, means for measuring or controlling differential pressure of a fluid across a bed of sample, and means for quantitatively diluting and transferring an aliquot of liquid containing a dissolved solute of the ingredient. A method of processing dissolution testing data includes steps of receiving, or receiving and computing, determined time profile data of a property of dissolution, and constructing in accordance with the determined time profile data a function of the property, or an algebraic transform thereof, versus cumulative mass of an ingredient dissolved, or an algebraic transform thereof.

### SUMMARY OF THE INVENTION

The present invention relates to method of manufacturing and testing solid dosage products, and apparatus for the testing. More particularly, it relates to method of manufacturing a solid dosage product to achieve desired or controlled rate of dissolution of an ingredient thereof in vivo, method of testing rate of dissolution for the manufacturing, apparatus for the testing, and method of processing dissolution testing data.

The invention, in one aspect thereof, is a method of manufacturing a solid dosage product to achieve desired or controlled rate of dissolution of an ingredient thereof, as the dissolution occurs in a complex in vivo dissolution environment, the complex in vivo dissolution environment comprising an in vivo dissolution medium and a complex in vivo hydrodynamic dissolution condition.

The method, in accordance with a principal feature of the invention, overcoming one or more problems of the prior art, comprises steps of determining, evaluating, and controlling at least one property of dissolution of the ingredient of the solid dosage product, or of a sample thereof, each of said at least one property being in an advantageous form and/or determined and evaluated in an advantageous manner heretofore unattained by the prior art.

In certain preferred embodiments of the method, a property is determined, evaluated, and controlled as a function of, at least, cumulative mass of the ingredient dissolved from a sample of the solid dosage product. A function of, at least, cumulative mass of an ingredient dissolved from a sample of a solid dosage product, is called, hereinafter sometimes, an “advantageous function”.

A said advantageous function may comprise, further, as an independent variable, time of contact between the sample and the dissolution medium (hereinafter sometimes, “contact time with dissolution medium”, “dissolution medium contact time”, or simply “contact time”), independently variable from the cumulative mass.

One of the at least one property of dissolution, as a said advantageous function, heretofore until the present invention undetermined, unevaluated, and uncontrolled in methods of manufacturing in the prior art, is called, hereinafter sometimes, an “r(M) function”. In contrast to determining and evaluating differential rate of dissolution or cumulative mass dissolved, each as a function of time of a dissolution process, which is taught by prior art methods, method of the present invention, in certain preferred embodiments thereof, teaches determining and evaluating differential rate r of an ingredient of a solid dosage product, or of a sample thereof, as a function, r(M), of cumulative mass M of the ingredient dissolved from the solid dosage product, or from the sample thereof. Preferably and advantageously, an r(M) function is determined and evaluated under a given dissolution condition representing or simulating at least one aspect, i.e., a component, of dissolution condition of an in vivo dissolution process. Preferably further, an r(M) function is determined and evaluated under each of a plurality of component or fundamental hydrodynamic dissolution conditions, or under a controlled combination thereof, each thereof simulating at least a part, or a fundamental aspect, of hydrodynamic dissolution condition of the in vivo dissolution process. The plurality of component or fundamental hydrodynamic dissolution conditions comprises one or more fundamental hydrodynamic dissolution conditions selected from a group consisting of: (A.) discrete settlement hydrodynamic dissolution condition; (B.) discrete fluidization and settlement hydrodynamic dissolution condition; (C.) pressure-sensitive packed bed hydrodynamic dissolution condition; and (D.) flow-sensitive fixed position hydrodynamic dissolution condition.

Differential rate, r, determined under a given dissolution condition and evaluated as a said advantageous function comprising further an independent variable of dissolution medium contact time, t_{c}, in accordance with a preferred embodiment of method of the invention, provides a said advantageous function hereinafter sometimes called an “r(M,t_{c}) function”.

Differential rate, r, determined and evaluated as a function of M and a dependent variable of dissolution medium contact time, t_{c}, for a given dissolution process (i.e., under a full course of time-function of dissolution condition thereof), where t_{c} is identical as t (time of dissolution, dependent on M given the dissolution process), provides a function hereinafter sometimes called an “r(M,t_{c}) curve”.

An r(M,t_{c}) function, determined and evaluated in accordance with a preferred embodiment of method of the invention, under a given dissolution condition, is associated with a 3-dimensional (3-D) surface, hereinafter sometimes called an “r(M,t_{c}) surface”, in a 3-D space with r, M, and t_{c} as its coordinates. The 3-D surface characterizes dissolution of the ingredient dissolving under the given dissolution condition.

An r(M,t_{c}) curve, determined or evaluated for a given dissolution process, is associated with a 3-D curve in the 3-D space. The 3-D curve characterizes dissolution of the ingredient in the given dissolution process.

An r(M) function, determined and evaluated in accordance with a preferred embodiment of method of the invention, and each of an M(t) and an r(t) function, determined in accordance with a traditional method, are each associated with a 2-dimensional (2-D) side view of a 3-D r(M,t_{c}) curve.

While each of an M(t) and an r(t) function is generally dependent on time-function of dissolution condition of a dissolution process, and thus represents a dynamic property thereof, an r(M) function determined and evaluated under a given dissolution condition (including t_{c} where r depends on t_{c}) in accordance with a preferred embodiment of method of the invention, and an r(M,t_{c}) function in accordance with a preferred embodiment thereof, are substantially independent of a dissolution process, and represent a static and intrinsic property of a dissolving solid dosage product in any dissolution process comprising the given dissolution condition.

An r(M) function, determined and evaluated in accordance with a preferred embodiment of method of the invention, under a member of certain given dissolution conditions (including t_{c} where r depends on t_{c}), may be used to characterize fundamental aspects, e.g., dominant mechanism and kinetic order, of dissolution of a dissolving solid, among other utilities.

The disclosure herein teaches treating a complex hydrodynamic dissolution condition typically found in an in vivo biological dissolution process or environment, as a combination, or a mixture, of component hydrodynamic dissolution conditions comprising all or some of said fundamental hydrodynamic dissolution conditions, in accordance with preferred embodiments of method of the invention.

The disclosure herein further teaches that, in accordance with preferred embodiments of method of the invention, differential rate of dissolution of an ingredient of a solid dosage product dissolving in a complex in vivo dissolution process in a complex in vivo dissolution environment, such as the lumenal dissolution environment of gastrointestinal (GI) tract of a live human, at any time of the in vivo dissolution process, may be expressed essentially as a linear combination of differential rates of dissolution, each as a said advantageous function, of the ingredient of the solid dosage product dissolving under a plurality of component, e.g., fundamental dissolution conditions. Given the in vivo dissolution environment, and transit properties of the solid dosage product therein, a collection of the differential rates of dissolution under the component e.g. fundamental dissolution conditions, each as the said advantageous function, essentially determines the differential rate of dissolution in the in vivo dissolution environment. Controlling transit properties, and the differential rates of dissolution under the component e.g. fundamental dissolution conditions, each as a said advantageous function, provides, in accordance with an advantageous feature of method of the invention, a basis for controlling differential rate of dissolution in the in vivo dissolution environment.

Another of said at least one property of dissolution, as a said advantageous function, heretofore until the present invention undetermined, unevaluated, and uncontrolled in methods of manufacturing a solid dosage product in the prior art, is called, hereinafter sometimes, vertical velocity of fluidization. In accordance with the teaching of the inventive method of manufacturing, vertical velocity of fluidization in an in vivo dissolution medium or an in vitro dissolution medium substantially simulating the in vivo dissolution medium, is a fundamental property of particulates of a dissolving solid dosage product that, when controlled together with control of an approximate size and cohesiveness of the particulates, allows control of transit properties thereof in a complex in vivo dissolution environment. In accordance with the teaching of the inventive method of manufacturing, control of vertical velocity of fluidization of a particulate also controls probability of the particulate dissolving in a fluidized state, in contrast to a settled state, at any given point of time in an in vivo dissolution process, given a hydrodynamic dissolution condition thereof and given an in vivo dissolution medium thereof. As will be seen in the present disclosure, a particulate dissolving in a fluidized state is subject to a relative local velocity of dissolution medium flow controlled by parameters different from a settled state, which may result in different rates of dissolution of an ingredient of the particulate. In accordance with the teaching of the inventive method of manufacturing, control of vertical velocity of fluidization controls relative local velocity of dissolution medium flow for a particulate dissolving in a fluidized state, and thereby controls, in part, rate of dissolution of the particulate in the fluidized state.

Another of said at least one property of dissolution, as a said advantageous function, heretofore until the present invention undetermined, unevaluated, and uncontrolled in methods of manufacturing in the prior art, is specific hydraulic conductivity or specific hydraulic resistance of a particulate or particulates of a solid dosage product containing an ingredient of interest. In accordance with the teaching of the inventive method of manufacturing, control of the specific hydraulic conductivity or specific hydraulic resistance allows substantial control of rate of dissolution of the ingredient dissolving from the particulate or particulates in a settled state.

In other aspects, the invention provides new and advantageous steps of method, and parts and construction of dissolution testing cell and dissolution testing apparatus for use with the method, of testing a solid dosage product to determine one or more of said at least one property of dissolution, each in the advantageous form, and/or determined and evaluated in the advantageous manner, e.g., as a said advantageous function, under one or more of said fundamental hydrodynamic dissolution conditions, as well as under other desired hydrodynamic dissolution conditions.

The dissolution testing cell of the invention comprises a cell cavity and at least one side opening thereto selected from a group consisting of: (A.) tangential opening, and (B.) ring-shaped opening.

The dissolution testing apparatus comprises: (A.) first pump means driving a stream of dissolution medium at a controlled or programmed flow rate; (B.) second pump means withdrawing a sample from a liquid or driving a sample out of a liquid; (C.) cumulative vessel storing a solute dissolved in a dissolution medium exited from a dissolution testing cell during a dissolution test; (D.) sampling means providing a sample for detection of a solute dissolved in a dissolution medium; (E.) first switching valve means switching among at least two positions comprising first position and second position, the first position allowing a sample from the dissolution testing cell to travel to the sampling means via a fluid conduit, under aid from either one or both of the first and the second pump means, and the second position allowing a sample from the cumulative vessel; and (F.) control means controlling at least the independent functioning of the first and the second pump means, and the functioning of the first switching valve means.

In yet other aspects, the invention provides new and advantageous steps of method of processing dissolution testing data.

The invention will be more fully understood from the following detailed description, when read in connection with the accompanying drawings.

### BRIEF DESCRIPTION OF THE DRAWINGS

In the drawings:

FIGS. 1A and 1B are diagrams showing an r(M) function and a group of r(M,t_{c}) curves, respectively, in a graphic form, determined and evaluated in accordance with a preferred embodiment of method of the invention;

FIG. 2 is a flow chart highlighting inventive steps of a method of manufacturing a solid dosage product in accordance with a preferred embodiment of method of the invention;

FIGS. 3A, 3B, and 3C are, respectively, a top plan view, a bottom plan view, and a front sectional view (taken along line A-A′), of a first dissolution testing cell constructed in accordance with a preferred embodiment of apparatus of the invention;

FIG. 3D is an interior bottom plan view thereof;

FIG. 3E is a front sectional view of a sampling probe therefor;

FIGS. 4A, 4B, and 4C are, respectively, a bottom plan view, a front sectional view (taken along line B-B′) and a side sectional view (taken along line C-C′), of a second dissolution testing cell constructed in accordance with a preferred embodiment of apparatus of the invention;

FIGS. 5A, 5B, and 5C are, respectively, a top plan view, a side sectional view (taken along line D-D′), and an exploded side sectional view of a third dissolution testing cell constructed in accordance with a preferred embodiment of apparatus of the invention;

FIG. 5D is a bottom plan view of an upper part of the third dissolution testing cell;

FIGS. 6A, 6B, and 6C are, respectively, a top plan view, a bottom plan view, and a front sectional view (taken along lines E-E′), of a fourth dissolution testing cell constructed in accordance with a preferred embodiment of apparatus of the invention;

FIG. 7A is a diagram showing fluidics of a first dissolution testing apparatus in use with the first dissolution testing cell of FIGS. 3A, 3B, and 3C in accordance with a preferred embodiment of the invention;

FIG. 7B is a front sectional view of a preferred cumulative vessel;

FIGS. 7C and 7D are, respectively, a top plan view and a front sectional view (taken along line F-F′) of a multi-stream sampling valve (preferred embodiment);

FIGS. 7E and 7F are a top plan view of rotor of the multi-stream sampling valve of FIGS. 7C and 7D, in position zero (0) and position one (1), respectively;

FIG. 8 is a diagram showing fluidics of a second dissolution testing apparatus in use with the second dissolution testing cell of FIGS. 4A, 4B, and 4C in accordance with a preferred embodiment of the invention;

FIG. 9A is a diagram showing fluidics of a third dissolution testing apparatus in use with the third dissolution testing cell of FIGS. 5A, 5B, 5C, and 5D in accordance with a preferred embodiment of the invention;

FIG. 9B illustrates a switching position of a switching valve of the third dissolution testing apparatus, different from a position shown in FIG. 9A;

FIG. 10A is a diagram showing fluidics of a fourth dissolution testing apparatus in use with the fourth dissolution testing cell of FIGS. 6A, 6B, and 6C in accordance with a preferred embodiment of the invention;

FIG. 10B illustrates an orientation of a rotational cell holder, FIGS. 10C and 10D switching positions of a switching valve, of the fourth dissolution testing apparatus of FIG. 10A, each different from an orientation and position shown in FIG. 10A.

### DETAILED DESCRIPTION OF THE INVENTION

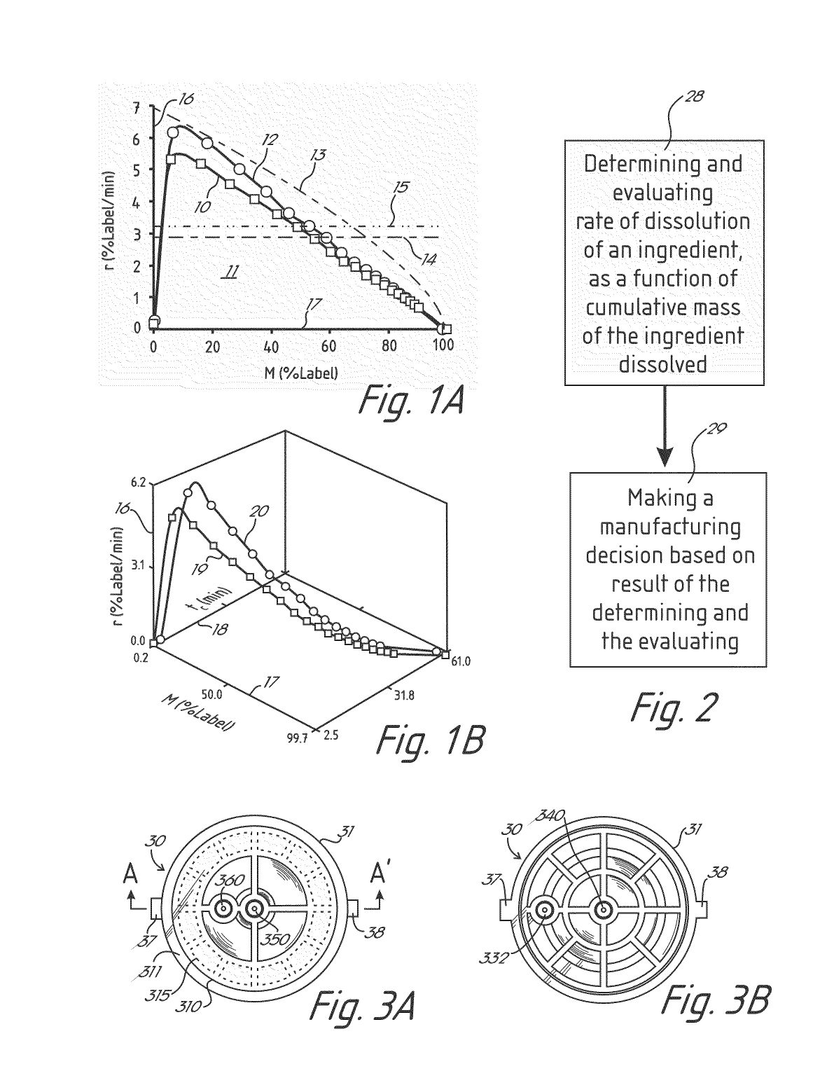

Referring to FIG. 1A, curve 10 is a graphic form of an r(M) function determined and evaluated for a pharmaceutical active ingredient of an immediate release disintegrating pharmaceutical tablet (Kroger Acetaminophen Tablet 500 mg, Lot No. 5EF015) dissolving in a simulated gastric fluid (in the present embodiment, deionized water) under a discrete fluidization and settlement hydrodynamic dissolution condition of an in vitro dissolution process.

Curve 10 is determined and constructed as follows.

First, values of differential rate of dissolution of the active ingredient of the pharmaceutical tablet are experimentally determined at a plurality of points of time in the in vitro dissolution process, each of the values determined under a same dissolution condition. The dissolution condition is described in more detail hereinafter in connection with detailed description of the discrete fluidization and settlement hydrodynamic dissolution condition. The values, determined at the plurality of points of time under the discrete fluidization and settlement hydrodynamic dissolution condition, numerically express a function of differential rate of dissolution versus time of the dissolution process (herein sometimes, “time of dissolution”, or, interchangeably, “dissolution time”). The function is denoted mathematically as r(t), where r indicates differential rate of dissolution as a dependent variable and t time of dissolution an independent variable.

Next, values of cumulative mass of the ingredient dissolved are computed from the values of differential rate of dissolution at each of the plurality of points of time by means of numerical integration observing the following integration equation:
M(t)=∫₀^{t}r(t)·dt (eq. 1)
where t denotes the time; M(t) cumulative mass M of the ingredient dissolved at time t; and remaining symbols either are as defined above or have their ordinary mathematical meanings.

The values of cumulative mass of the ingredient dissolved thus obtained, at the plurality of points of time, numerically express a function of cumulative mass of the ingredient dissolved versus time of the dissolution process, i.e., M(t), where cumulative mass of the ingredient dissolved M is a dependent variable and time of dissolution t an independent variable.

Next, the variable of differential rate of dissolution is expressed as a function of the variable of cumulative mass of the ingredient dissolved by relating the value of the variable of cumulative mass of the ingredient dissolved to the value of the variable of differential rate of dissolution (i.e., pairing the latter with the former) at each point of the plurality of points of the common independent variable of dissolution time. The function forms an r(M) function, expressing a determined relationship between the variable of differential rate of dissolution as a dependent variable and the variable of cumulative mass of the ingredient dissolved as an independent variable, for the pharmaceutical active ingredient of the immediate release pharmaceutical tablet dissolving in the simulated gastric fluid in the in vitro dissolution process. Because each of the values of differential rate of dissolution is determined under a same dissolution condition, i.e., the discrete fluidization and settlement hydrodynamic dissolution condition (described in further detail hereinafter) in the in vitro dissolution process, the r(M) function, in accordance with an advantageous feature of method of the invention, represents an r(M) function for the ingredient of the solid dosage product dissolving under a given dissolution condition, i.e., the discrete fluidization and settlement hydrodynamic dissolution condition, in the present embodiment.

Finally, curve 10 is constructed by plotting, in accordance with the determined r(M) function, the variable of r differential rate of dissolution 16, expressed in a unit of mass of the ingredient dissolved per unit time, against the variable of M cumulative mass of the ingredient dissolved 17, expressed in a unit of cumulative mass of the ingredient dissolved. Such a plot (e.g., curve 10) is called a “differential rate-cumulative mass dissolved plot”, or “r(M) plot” (or, r-M plot) in short, sometimes herein.

The embodiment illustrates, by way of example, an important feature of method of the invention. In accordance with the feature, certain embodiments of method of the invention comprise a step of determining and evaluating, including based on determined data constructing, differential rate of dissolution of an ingredient of a solid dosage product, or of a sample thereof, as a function of cumulative mass of the ingredient dissolved from the solid dosage product, or from the sample thereof, in a dissolution process. The differential rate of dissolution is determined and evaluated as a said function preferably under each of one or more of controlled dissolution conditions. Preferred members of the controlled dissolution conditions are described in detail in disclosure of further aspects of the invention hereinafter.

In determining the curve 10 r(M) function, time of contact t_{c} between the acetaminophen tablet and the dissolution medium, is the same as time of dissolution of the experimental dissolution process t, which was time of dissolution under the dissolution condition t_{d} plus three (3) minutes (3 min) of a period of dissolution medium contact time under a static hydrodynamic condition (see experimental details hereinafter). Plotting r against both M and t_{c} instead of only M provides an r(M,t_{c}) curve, shown at 19 in FIG. 1B.

Referring to FIG. 1B, it can be seen that the r(M,t_{c}) curve 19 is a 3-D curve, of which the r(M) function curve 10 of FIG. 1A is a side view through a plane defined by axes r (16, FIG. 1B) and M (17). Side views through planes defined by axes M(17) and t_{c} (18), and axes r (16) and t_{c} (18), yield an M(t) and an r(t) function (not drawn), respectively, wherein t (time of dissolution of the dissolution process) is identical as t_{c}.

A second curve 12 is shown in FIG. 1A and a corresponding second curve 20 in FIG. 1B. The second curves 12 and 20 are determined on a second acetaminophen tablet from a same lot as the tablet for first curves 10 and 19, in the same manner in which the first curves 10 and 19 are determined, except that the second acetaminophen tablet is exposed to the dissolution medium in a static condition for eight (8) minutes instead of three (3) prior to being subjected to dissolution under a same discrete fluidization and settlement hydrodynamic dissolution condition. Thus, except for the experimental data point at time zero and additional data points determined for curves 10 and 19 towards end of the curves, dissolution medium contact time t_{c} for each experimental data point of the second curves 12 and 20 is five (5) minutes longer than a corresponding experimental data point of the first curves 10 and 19.

While only two curves are determined and constructed for the acetaminophen tablet product in each of the FIG. 1A and FIG. 1B embodiments of method of the invention, it is understood that additional such curves may be determined, constructed, and included in an embodiment of method of the invention to provide data points at additionally different t_{c}.

It is also understood that a plurality of r(M,t_{c}) curves, evaluated in graphic form such as those in FIG. 1B, defines a curved surface, i.e., an r(M,t_{c}) surface (not drawn in FIG. 1B but to be envisioned as a 3-D curved surface passing through curved lines 19 and 20).

Further, it is understood that a plurality of r(M) curves, evaluated in graphic form such as those in FIG. 1A, represents a lined side view (two lines 10 and 12 presently shown in FIG. 1A) of the 3-D curved surface, viewed through the plane defined by axes r (16, FIG. 1B) and M (17, FIG. 1B).

Referring to curve 10 in FIG. 1A, the r(M) function (curve 10) is used, advantageously, to provide fine monitoring of rate of dissolution of different portions of the active ingredient of the acetaminophen tablet under a given dissolution condition (i.e., presently the discrete fluidization and settlement hydrodynamic condition). Curve 10 shows that rate of an initial portion of acetaminophen of the acetaminophen tablet, at 0% label dissolved, is very low. The rate rapidly increases to a peak of about 5.3% label/min at about 5% label dissolved. Thereafter the rate decreases almost linearly as the active ingredient progressively dissolves from the tablet, until complete dissolution (i.e., 100% dissolved, taking into consideration of content deviation from label amount). Such a feature of fine monitoring may be used in fine-tuning and control of formulation and manufacturing process variables, to achieve desired rate performance of dissolution of an ingredient of a solid dosage product. The feature is especially useful when a product contains different portions of an active ingredient that are intended to be released at different rates (e.g., a controlled release pharmaceutical tablet that contains a fast release loading dose and a slow release maintenance dose, data not shown).

Traditional methods that teach determination and construction of M(t) or r(t) functions, in contrast, do not have this advantage.

Traditional methods, in contrast, teach monitoring of cumulative mass dissolved and differential rate of dissolution each as a function of time of a dissolution process.

As such, an M(t) or r(t) function, determined in accordance with a traditional method, is dependent on not only a dissolving solid but also such other process-related factors as dissolution time delay and dissolution process-specific time-function of dissolution condition especially hydrodynamic dissolution condition. Because of this, an M(t) or r(t) function determined in accordance with a method of the prior art is process-dependent and extremely sensitive to time-function of dissolution condition of a dissolution process (hereinafter sometimes, “process-dependent and time-sensitive”).

As time-function of dissolution condition of an in vivo dissolution process generally differs from that of an in vitro dissolution process in the prior art (the latter generally fails to reproduce the former), an M(t) or an r(t) function determined in an in vitro process in the prior art generally differs from, and indeed cannot be expected to represent, that of an in vivo process. Attempts to reproduce an in vivo dissolution condition especially hydrodynamic dissolution condition (which is usually a complicated function of time and space) in the prior art have generally proven to be futile. Exact dissolution condition especially hydrodynamic dissolution condition of an in vivo biological environment (e.g., that of the GI tract of a live human) is generally unknown. At the same time, dissolution condition especially hydrodynamic dissolution condition of an in vivo biological environment (e.g., the GI tract) is generally recognized as highly complex, varying as a complicated function of time and space, and from one live test subject to another. Even under certain in vitro test conditions of the prior art (e.g., USP Type I, II, III, and IV methods as of the effective filing date of the present application), which are supposed to be under strict experimental control, local hydrodynamic dissolution condition experienced by one sample in one in vitro dissolution process (e.g., that in one dissolution testing vessel in a six-vessel USP type II dissolution test) may not be exactly the same as that by another sample in another in vitro dissolution process (e.g., that in another dissolution testing vessel in the six-vessel USP type II dissolution test). Stirred tank hydrodynamic dissolution conditions, e.g., those of the USP type I and type II tests as of the effective filing date of the present application, are increasingly realized by the scientific community as chaotic (Muzzio et al, 2005, Int. J. Pharm., 292: 17-28). Seemingly under control, they can easily differ widely among replicate tests (i.b.i.d).

Because of a combination of failure in reproducing an in vivo process, lack of sufficient control of an in vitro process especially hydrodynamic dissolution conditions, and the process-dependent and time-sensitive nature of M(t) and r(t) functions, high variability in test results and failure of in vitro-in vivo correlation (IVIVC) generally occur in the prior art.

Because of the process-dependent and time-sensitive nature, a determined M(t) or r(t) function performs poorly in characterizing (static) property of dissolution of an ingredient of a solid dosage product.

An r(M) function, determined and evaluated in accordance with a preferred embodiment of method of the invention, under a given dissolution condition, on the other hand, focuses on characterizing an ingredient of a solid dosage product itself (involving r and M, instead of t), as the ingredient dissolves through a dissolution process. An r(M) function measures changes in a dissolving ingredient, and/or matrix, as the ingredient dissolves. Determined under a given dissolution condition (including t_{c} where r depends on t_{c}), an r(M) function may be substantially independent of a dissolution process (i.e., true in any dissolution process comprising the given dissolution condition).

An r(M, t_{c}) function, determined in accordance with a preferred embodiment of method of the invention, provides characterization of rate of dissolution of an ingredient of a solid dosage product, as a function of, further, dissolution medium contact time. The latter may affect exposed surface area of a dissolving ingredient in a case such as a polymer coated and a disintegrating pharmaceutical tablet, wherein dissolution of a coating and disintegration of the tablet may be heavily dependent on dissolution medium contact time.

Referring to FIG. 1A, a comparison of differential rate of dissolution of acetaminophen from the two tablets is made on a mass by mass basis, at same degrees of dissolution of acetaminophen from the two tablets. More specifically, for example, at 0% label of the active dissolved, both tablets are seen to show a very low dissolution rate of the active. At about 20% label dissolved, the tablet that had an extra five minutes of contact with dissolution medium (at each experimental data point) is seen to show a dissolution rate (curve 12) almost 1% label/minute higher than the other (curve 10). Difference in dissolution rates between the two tablets are seen to gradually decrease as the active ingredient gradually dissolves, to values very small after about 50% label of the active was dissolved (FIG. 1A).

The very low dissolution rates of the active ingredient at 0% label dissolved was used to infer a very small surface area of the acetaminophen active exposed to dissolution medium for both tablets when intact. The higher rate of the curve 12 tablet at 20% label dissolved (FIG. 1A) was used to infer a higher degree of exposure of its active to the dissolution medium, which may have resulted from a higher degree of disintegration of the tablet, or further disintegration of granules thereof. The higher degree of disintegration, in turn, may have been a result of the tablet's extra contact time with the dissolution medium. The gradual decrease in difference in rates between the two tablets after 50% label of the active dissolved was used to infer a diminishing role of the disintegration in influencing the degree of exposure of the active to the dissolution medium, which may be the case at late stages of the dissolution process, when the disintegration reached toward completion.

Referring to curves 10 and 12 in FIG. 1A again, as dissolution rate of the immediate release disintegrating acetaminophen tablet product has some dependency on dissolution medium contact time t_{c} during early stages of a dissolution process before disintegration is complete, curves 10 and 12 do not completely overlap.

When a dissolution rate is substantially independent of t_{c}, as may be the case for certain non-disintegrating controlled release beads under given dissolution conditions, and for completely disintegrated granules of certain immediate release solid dosage forms, r(M) functions of different t_{c} will show substantial overlap.

On the other hand, when a dissolution rate is substantially influenced by t_{c}, as may be the case for certain polymer-coated pharmaceutical tablets and in early stage of a dissolution process of an immediate release disintegrating tablet, r(M) functions of different t_{c} will show wide gaps in between.

In FIG. 1A, the linear behavior of the portion of the curve 10 r(M) function in the mass range after 0% label or so dissolved was surprising as, initially, it was thought that the function might behave in a curved manner over the mass range, as a theoretically constructed r(M) function would have suggested if certain theoretical models of dissolution known in literature were assumed. In FIG. 1A, shown in broken line illustration 13 is a theoretical r(M) function constructed on assumption that dissolution of disintegrated granules of a tablet follows a so-called Hixson-Crowell model (Hixson, A and Crowell, J, 1931, Ind. Engg. Chem. 23:923-931), which in turn assumes a Noyes-Whitney theory (Noyes, A A and Whitney, W R, 1897, J. Am. Chem. Soc., 19:930-934). The clear deviation of both of the determined curves 10 and 12 from the theoretically constructed function 13 shows that a Hixson-Crowell model does not accurately account for dissolution behavior of the acetaminophen tablets tested under the discrete fluidization and settlement hydrodynamic dissolution condition.

The linear portion of the curve 10 (FIG. 1A), rather, suggests a behavior of first-order like kinetics. As such, the linear portion may be described by a simple first-order kinetic constant k. The first-order kinetic constant may be determined from slope of the linear portion. For curve 10, k was determined at 0.060 min⁻¹, and for curve 12, 0.071 min⁻¹.

While the immediate release, disintegrating acetaminophen tablets tested in the FIG. 1A embodiment of method of the invention, under the discrete fluidization and settlement hydrodynamic dissolution condition (further disclosure hereinafter), show apparent linear behaviors (curves 10 and 12, FIG. 1A), it is to be understood that the shape of an r(M) function determined under a given dissolution condition or for a given dissolution process may vary widely depending on physical structure and dissolution mechanism of a dissolving solid dosage product, and depending on the given dissolution condition (including any effect from dissolution medium contact time t_{c}) or the given dissolution process (including time-function of dissolution condition thereof). Determined under a given a dissolution condition (including t_{c} where t_{c} has an effect on r) in accordance with a preferred embodiment of method of the invention, the shape of an r(M) function may be used to provide an insight into the physical structure and dissolution mechanism of a solid dosage product, and a guidance to, or a control of, manufacturing same.

An example of guidance to or control of manufacturing is the use of an r(M) function determined under a given in vitro dissolution condition (including t_{c}, where r is dependent on t_{c}) to monitor deviation if any of a solid dosage product within a production batch, and from one batch to another, material and process being maintained, adjusted, and/or halted in a process of the manufacturing, where necessary to confine the r(M) function to a target range both in shape of the r(M) function and in value of dissolution rates (see also computation of mean differential rate of dissolution over mass in further disclosure of the invention hereinafter). In a case of pharmaceutical product, an r(M) function determined under a given in vitro dissolution condition for a clinically successful trial batch of a solid dosage product may be used as a target towards which scale-up developments, formulation and process modifications including site changes, and product line extension developments may be guided. The target may also comprise quality control specification ranges established from r(M) functions of additional clinically successful trial batches, from knowledge of products similar in particulate physical attributes (more particularly, transit properties), and/or from in vitro-in vivo correlation (IVIVC) modeling and simulation studies (see further disclosure hereinafter).

For such use as a guidance, an r(M) function does not need to be determined under a complex in vitro dissolution condition that exactly reproduces a time- and space-varying, i.e., complex, in vivo dissolution condition. Rather, an r(M) function is preferably determined under a substantially simpler and easily controlled in vitro dissolution condition that simulates one aspect of the complex in vivo dissolution condition (See further disclosure hereinafter). For many oral solid dosage pharmaceutical products that dissolve following a pH- and surfactant-independent dissolution mechanism, an in vitro dissolution medium needs only to be aqueous based, and an r(M) function determined in the aqueous in vitro dissolution medium is linearly correlated with an r(M) function of the solid dosage product dissolving in another aqueous dissolution medium of a different pH, surfactant concentration, an/or temperature, under a given common hydrodynamic dissolution condition. Where the dissolution mechanism is dependent on pH and/or surfactant, e.g., in a case of disintegrating immediate release pharmaceutical tablet the disintegration of which is pH- and/or surfactant-dependant, an in vitro dissolution medium of time-programmed, varying pH and/or surfactant composition may be used.

An r(M) function determined under an in vitro dissolution condition in such a manner does not provide an in vitro dissolution rate function that directly reproduces or mimics an exact in vivo rate function for an in vivo dissolution process (To do so, see further disclosure hereinafter). Rather, the r(M) function is intended to provide a detailed characterization of rate of dissolution of an ingredient of a solid dosage product, as the dissolution occurs under a given dissolution condition, and at various degrees of dissolution of the ingredient (with M as a measure of degree of dissolution).

Replicate determinations of an r(M) function of a solid dosage product, obtained on replicate units of the solid dosage product under an identical dissolution condition (including t_{c} if r depends on t_{c}), may be mathematically or statistically averaged, and variance of an average computed, for rate of dissolution r at each value of M. The average and variance provides a measure of statistical distribution of rate of dissolution of an ingredient of the solid dosage product at each degree M of dissolution of the ingredient, under the identical dissolution condition. This is essentially measurement of a product variability, and is in contrast to traditional teaching of statistical averaging, and computation of variance, of replicate determinations of an M(t) or r(t) function. The traditional teaching implies assumption of a physically ill-defined “average process” of dissolution (as t is a process variable). Any computation of variance according to the traditional teaching relates to the physically ill-defined “average process”, bearing no simple or direct relationship to product variability. Because both M and r can be extremely, and in the case of M cumulatively, t-sensitive, variance computed in accordance with the traditional teaching is usually high but typically not indicative of variability of the product.

To reduce variability of dissolution of a solid dosage product in vivo in accordance with a preferred embodiment of method of the invention, formulation and manufacturing process variables for the solid dosage product may be controlled to the effect of a reduced variance in replicate determinations of an r(M) function in vitro. Such controlling may involve, e.g., limiting properties (e.g., particle size distribution, grade, vertical velocity of fluidization, water content, hydrate and crystal forms etc.) of a raw material to a certain range, adjusting the properties, amount, and composition of a raw material, and changing process parameters such as water content, tableting pressure, and blending time, etc. For an example of adjusting and controlling composition and process variables of a pharmaceutical product, see, e.g., U.S. Pat. No. 6,596,307, issued to Brown Jr et al on Jul. 22, 2003, the disclosure of which is incorporated herein in entirety by way of reference.

An r(M) function may be used to provide an absolute measurement of rate of dissolution of an ingredient of a solid dosage product under a given dissolution condition (including t_{c} where r depends on t_{c}), and may be used to rank the solid dosage product in a cross-product or cross-ingredient dissolution rate ranking system. An r(M) function determined for one solid dosage product may be directly compared with an r(M) function determined for another solid dosage product.

The term “determining”, as used herein in the present patent document, is a short form of the term “experimentally determining”, which, in either of its short or full form as used herein, denotes obtaining value of (e.g., a property, a metric, or a function) by way of an experimental procedure or by way of a procedure comprising at least an experimental step.

The terms “determination”, “determine”, and “determined”, as used herein, are noun, verb, and past tense forms, respectively, of the term “determining”.

The term “evaluating”, as used herein, denotes comparing, correlating, constructing, displaying, mathematically or statistically treating including simple and weighted averaging and linearly combining, or otherwise manipulating (e.g., differential rate of dissolution r as a function of cumulative mass dissolved M).

The terms “evaluation”, “evaluate”, and “evaluated” as used herein, are noun, verb, and past tense forms of the term “evaluating”, respectively.

The term “as a function of (e.g., cumulative mass dissolved)”, as used herein, denotes treating (e.g., cumulative mass dissolved) as independent variable (of a dependent variable expressed by the function), the function having value (of the dependent variable) at each of a plurality of at least three, preferably at least five points of value of an independent variable, or averaged over each of at least three, preferably at least five non-overlapping ranges of value of the independent variable. Unless specifically indicated otherwise in a context of use herein, the term implies that value of an independent variable can vary independently from value of any other independent variable that the function may have.

The term “differential rate of dissolution”, when used herein in a narrow sense as indicated by a reference in a context to the following equation (eq. 2) or symbol dM/dt, denotes a property mathematically defined as:

$$r = \frac{ⅆ M}{ⅆ t} \qquad ( eq . 2 )$$

where r denotes differential rate of dissolution, and dM/dt first derivative of an M(t) function, the M(t) function expressing cumulative mass M of an ingredient dissolved from a sample of a solid dosage product in a dissolution process as a function of time t thereof.

The term “mean differential rate of dissolution over time”, or its short form “mean differential rate over time”, when used herein in a narrow sense as indicated by a reference in a context to the following equation (eq. 3) or symbol ΔM/Δt, denotes a property mathematically defined as:

$${r}_{mean} = \frac{Δ M}{Δ t} \qquad ( eq . 3 )$$

where rₘₑₐₙ denotes mean differential rate of dissolution over time, ΔM a range of mass of an ingredient dissolved from a sample of a solid dosage product, and Δt a range of time taken to dissolve the range of mass ΔM.

The term “differential time of dissolution”, when used herein in a narrow sense as indicated by a reference in a context to the following equation (eq. 4) or symbol dt/dM, denotes a property mathematically defined as:

$$τ = \frac{ⅆ t}{ⅆ M} \qquad ( eq . 4 )$$

where τ denotes differential time of dissolution, and dt/dM first derivative of a t(M) function, the t(M) function expressing cumulative amount of time t taken to dissolve cumulative mass M of an ingredient of a sample of a solid dosage product in a dissolution process.

The term “mean differential time of dissolution over time”, or its short form “mean differential time over time”, when used herein in a narrow sense as indicated by a reference in a context to the following equation (eq. 5) or symbol Δt/ΔM, denotes a property mathematically defined as:

$${τ}_{mean} = \frac{Δ t}{Δ M} \qquad ( eq . 5 )$$

where τₘₑₐₙ denotes mean differential time of dissolution over time, ΔM a range of mass of an ingredient dissolved from a sample of a solid dosage product, and Δt a range of time taken to dissolve the range of mass ΔM.

When used herein in a broad sense, i.e., without specifically referring to equation (eq. 2) or the symbol dM/dt in a context, the term “differential rate of dissolution” embraces, in scope of meaning, the term “mean differential rate of dissolution over time”, and denotes a property defined by either equation (eq. 2) or equation (eq. 3) wherein Δt is sufficiently small to allow ΔM/Δt to be a close approximation of dM/dt.

When used herein in a broad sense, i.e., without specifically referring to equation (eq. 4) or the symbol dt/dM in a context, the term “differential time of dissolution” embraces, in scope of meaning, the term “mean differential time of dissolution over time”, and denotes a property defined by either equation (eq. 4) or equation (eq. 5) wherein Δt is sufficiently small to allow Δt/ΔM to be a close approximation of dt/dM.

The term “cumulative mass of an ingredient dissolved from a sample of a solid dosage product”, as used herein, denotes total amount of an ingredient dissolved from a sample of a solid dosage product cumulatively by a point of time in a dissolution process. The term is sometimes shortened to “cumulative mass dissolved” or “cumulative mass” herein.

The term “rate of dissolution”, as used herein, is a short form of the term “differential rate of dissolution”, and specifically excludes, in scope of meaning, the term “cumulative mass of an ingredient dissolved”, as the short form sometimes embraces in language of teaching in prior art.

The symbol AUrMC represents an abbreviation of the term “area under the curve of an r(M) function”, and is used interchangeably therewith herein, denoting a property mathematically defined by the following equation:
AUrMC=∫_{A}^{B}r(M)·dM (eq. 6)
where AUrMC denotes area (e.g., 11, FIG. 1A) under the curve for a segment of a curve of an r(M) function (e.g., 10), between two points A and B (e.g., for area 11, A=0% label, B=100% label) on a horizontal axis of cumulative mass dissolved (in the FIG. 1A embodiment, cumulative fraction dissolved, 17); r(M) denotes the r(M) function defining the curve; and remaining symbols have their ordinary mathematical meanings. AUrMC is a said advantageous form of properties of dissolution taught herein.

The term “mean differential rate of dissolution over mass”, and its short form “mean differential rate over mass”, as used interchangeably herein, each denote a property mathematically defined by the following equation:

$$\overline{r} = \frac{AUrMC}{( B - A )} \qquad ( eq . 7 )$$

where r̅ denotes mean differential rate over mass for a given portion (i.e., the portion from A to B) of mass of an ingredient of a sample of a solid dosage product dissolving in a given dissolution process or under a given dissolution condition; and remaining symbols have same meanings as in equation (eq. 6) for the ingredient dissolving in the given dissolution process or under the given dissolution condition. Mean differential rate over mass is a said advantageous form of properties of dissolution taught herein.

The term “mean differential time of dissolution over mass”, and its short form “mean differential time over mass”, as used interchangeably herein, each denote a property mathematically defined by the following equation:

$$\begin{matrix}\overline{t} = \frac{1}{\overline{r}} \\ = \frac{( B - A )}{AUrMC}\end{matrix} \qquad ( eq . 8 )$$

where t̅ denotes mean differential time over mass, for a given portion (i.e., the portion from A to B) of mass of an ingredient of a sample of a solid dosage product dissolving in a given dissolution process or under a given dissolution condition; and remaining symbols have same meanings as in equation (eq. 6) and equation (eq. 7) for the ingredient dissolving in the given dissolution process or under the given dissolution condition. Mean differential time over mass is a said advantageous form of properties of dissolution taught herein.

In certain preferred embodiments of method of the invention, there is included a step of determining a member selected from a group consisting of AUrMC, mean differential rate over mass, and mean differential time over mass, each as a useful measure of rate of dissolution of an ingredient of a solid dosage product dissolving in a dissolution process or under a certain dissolution condition.

Mean differential time over mass, as defined by equation (eq. 8), with reference to a given portion of the mass, may also be used in accordance with a preferred embodiment of method of the invention, to provide a useful measure of total time required for complete dissolution of the given portion of the mass. For this reason, mean differential time over mass may also be called “required dissolution time” herein sometimes.

In the FIG. 1A curve 10 embodiment of method of the invention, for example, mean differential rate over mass for the first 50% of the labeled mass of the active ingredient of the pharmaceutical tablet is computed according to equation (eq. 7) at 4.2% label/min (4.2% label per minute), and mean differential time over mass, computed according to equation (eq. 8), at 0.24 min/% label (0.24 minutes per % label). For curve 12, on the other hand, mean differential rate over mass for the first 50% of the labeled mass has a value of 4.7% label/min and mean differential time a value of 0.21 min/% label. Over a full range of the labeled mass (0% to 100% label), the active ingredient of the pharmaceutical tablet tested in the curve 10 embodiment has a mean differential rate of 2.9% label/min (indicated by broken line 14 in FIG. 1A) and a mean differential time of 0.35 min/% label, compared to a mean differential rate of 3.3% label/min (15, FIG. 1A) and a mean differential time of 0.31 min/% label, of curve 12.

In accordance with the computation of mean differential rate over mass and mean differential time over mass, in the curve 10 embodiment of method of the invention, it may be said that the first 50% of the labeled mass of the active ingredient of the pharmaceutical tablet dissolves at an average rate of 4.2% label per minute, and it would take 50% label×0.24 min/% label=12.0 minutes for the first 50% of the labeled mass to completely dissolve under the given (discrete fluidization and settlement hydrodynamic) dissolution condition. In comparison, in the curve 12 embodiment, the average rate is 4.7% label per minute and it would take 10.5 minutes for the first 50% to dissolve under the given dissolution condition. The slightly higher rates and less time to dissolve seen in the curve 12 embodiment was interpreted as a result of an increased surface area of the dissolving ingredient exposed to dissolution medium due to a higher extent of disintegration as a result of the extra five minutes of dissolution medium contact time before dissolution under the discrete fluidization and settlement hydrodynamic dissolution condition. Similarly, it may be said that, over a full range of the labeled mass (0% to 100% label), the active ingredient of the pharmaceutical tablet in the curve 10 embodiment dissolves at an average rate of 2.9% label per minute under the given dissolution condition, and it would take 35 minutes for the full range of the labeled mass to dissolve (if all) under the given dissolution condition, compared to an average rate of 3.3% label per minute and 31 minutes to dissolve, in the curve 12 embodiment.

An AUrMC may be computed in accordance with a preferred embodiment of method of the invention from an r(M) function (e.g., curve 10) in mass domain by way of observing equation (eq. 6).

An AUrMC may also be computed in accordance with another embodiment of method of the invention, from an r(t) function in time domain by way of observing the following equation:
AUrMC=∫ₜ_{_{A}}^{t}^{_{B}}[r(t)]²·dt (eq. 9)
where t denotes time; t_{A} denotes value of the time, t, when cumulative mass dissolved, M, is at value of A; t_{B} denotes value of the time, t, when cumulative mass dissolved, M, is at value of B; [r(t)]² denotes square of r(t); and remaining symbols have same meanings as in equations (eq. 1), (eq. 6) and (eq. 7).

Equation (eq. 9) is derived from equation (eq. 6) by replacing variables and combining with a rearranged form of equation (eq. 2) wherein r is given the form of r(t).

In embodying method of the invention for computing AUrMC over a cumulative mass dissolved range ending at a point of complete (i.e., 100%) dissolution, a skilled artisan taught by the present disclosure will prefer the use of equation (eq. 6) over equation (eq. 9), because typically an r(M) function rapidly approaches zero as M approaches 100% dissolved but an r(t) function behaves like an asymptote as t increases towards infinite.

In the FIG. 1A embodiments of method of the invention, the variable of cumulative mass dissolved, M (axis 17), is expressed in an unit of “% label”, i.e., percent of the total labeled mass of the active ingredient of the pharmaceutical tablet. Correspondingly, the variable of differential rate of dissolution, r (axis 16), is expressed in an unit of “% label/min”, i.e., percent of the total labeled mass per minute.

When the variable of cumulative mass dissolved is expressed in such a unit of percent, or fraction, of a given total mass, an r(M) function may also be called an “r(F) function”, or “an r(M) function in an r(F) form” (F stands for fraction which in scope of meaning embraces percent), herein.

In comparison, the term “an r(M) function in an r(M) form”, as used herein, denotes specifically an r(M) function in which M is expressed in an absolute mass unit (e.g., milligrams or micrograms).

A useful feature of an r(M) function in an r(M) form determined and evaluated in accordance with a preferred embodiment of method of the invention is scalability among qualitatively identical fractions of a solid dosage product:

$$\begin{matrix}{r}_{j} ( {M}_{j} ) = {f}_{j} \cdot r ( \frac{{M}_{j}}{{f}_{j}} ) \\ = {f}_{j} \cdot r ( M )\end{matrix} \qquad ( eq . 10 )$$

where rⱼ(Mⱼ) denotes differential rate of dissolution, in absolute mass dissolved per unit time, of an ingredient of a j-th qualitatively identical fraction of a solid dosage product under a given dissolution condition at a point of Mⱼ of absolute mass of the ingredient cumulatively dissolved from the fraction; fⱼ a quantitative fractional number for the j-th qualitatively identical fraction, defined as ratio, wⱼ/w₀, of initial mass of the ingredient of the fraction, wⱼ, over initial mass of the ingredient of the whole product, w₀; and r(M) differential rate of dissolution of absolute mass of the ingredient of the whole solid dosage product under the given dissolution condition at a point of M=Mⱼ/fⱼ of absolute mass of the ingredient cumulatively dissolved from the whole solid dosage product.

A useful feature of an r(F) function determined and evaluated in accordance with a preferred embodiment of method of the invention is equality among qualitatively identical fractions of a solid dosage product when both differential and cumulative masses dissolved refer to a fraction, e.g., percent, of mass of an ingredient of a respective member of said qualitatively identical fractions, for example:
rⱼ(Fⱼ)=r(F) (eq. 11)
where rⱼ(Fⱼ) denotes differential rate of dissolution, in percent of mass dissolved per unit time, of an ingredient of a j-th qualitatively identical fraction of a solid dosage product under a given dissolution condition at a point of Fⱼ percent of mass of the ingredient of the fraction cumulatively dissolved therefrom; and r(F) differential rate of dissolution of percent of mass of the ingredient of the whole solid dosage product under the given dissolution condition at a point of F percent of mass of the ingredient of the whole solid dosage product cumulatively dissolved therefrom.

An M(t) function for a given dissolution process may be obtained analytically or numerically from its inverse function t(M). The t(M) function in turn may be obtained from an r(M) function determined for the given dissolution process in accordance with a preferred embodiment of method of the invention, by way of observing the following equation:

$$\begin{matrix}t ( M ) = {\int }_{0}^{M} τ \cdot ⅆ M \\ = {\int }_{0}^{M} \frac{ⅆ M}{r ( M )}\end{matrix} \qquad ( eq . 12 )$$

where symbols are either as defined in equation (eq. 4) and above or have their ordinary mathematical meanings.

An M(t) function for a given dissolution process may also be obtained from an r(M) function determined for the given dissolution process in accordance with a preferred embodiment of method of the invention numerically by way of stepwise application of the following finite difference equations starting from an initial condition of, e.g., i=0, tᵢ=0, and Mᵢ=0:
tᵢ₊₁=tᵢ+Δtᵢ and Mᵢ₊₁=Mᵢ+r(Mᵢ)·Δtᵢ (eq. 13)
where subscript i denotes a sequential step number, which is an integer selected from an integer series starting from zero; tᵢ, Mᵢ, r(Mᵢ) and Δtᵢ time of dissolution, cumulative mass dissolved, differential rate of dissolution and step size, respectively, at a step of sequential step number i; and subscript i+1 sequential step number of a next step.

Replacing the independent variable (i.e., M) of an r(M) function determined for a given dissolution process, with M(t) after computation thereof by way of observing either equation (eq. 12) or (eq. 13), provides an r(t) function for the given dissolution process in accordance with a preferred embodiment of method of the invention.

It is noted that techniques of differentiation and integration, whether analytically, numerically, or by means of an electronic differentiation or integration circuit, are by themselves well known techniques in the art of mathematics and engineering, and form no part of the present invention.

It is also noted that the specific, new, unique, and useful steps of computing and constructing r(M), r(t), and M(t) functions, disclosed hereinabove, form an inventive part of a preferred embodiment of method of processing dissolution testing data in accordance with the invention, comprising the steps of:
(a.) receiving data on both, or receiving data on one and computing data on the other, of an r(t) function and an M(t) function, each of the r(t) function and the M(t) function being determined for an ingredient of a solid dosage product, or a sample thereof, dissolving in a dissolution process, and having value at a plurality of points of time of the dissolution process; and
(b.) constructing, in accordance with the data received or received and computed in step (a.), a function of differential rate, or an algebraic transform thereof, of dissolution of the ingredient of the solid dosage product, or the sample thereof, versus cumulative mass, or an algebraic transform thereof, of the ingredient dissolved from the solid dosage product or the sample thereof in the dissolution process, the function having value at each of a plurality of points of the cumulative mass dissolved, or over each of a plurality of non-overlapping ranges thereof.

The term “particulate member”, as used herein, denotes a small sized (as compared to size of space of a dissolution environment in which the particulate member dissolves), solid or gel-like structure of a material, e.g., particles and granules of a disintegrated pharmaceutical tablet. The term may sometimes be shortened to the short form “particulate” herein.

The term “solid dosage product”, as used herein, denotes a dosage product that comprises at least one particulate member, the particulate member containing an amount of an ingredient soluble in a dissolution medium, or that can be released from a solid-bound or encapsulated form to the dissolution medium. Examples of solid dosage products include tablets, capsules, sustained release beads, liquid suspensions of particulates, inhalable powders, stents, solid implants, transdermal patches containing particulates, creams, among others.

The term “a sample of a solid dosage product”, as used herein, denotes a representative dosing unit of a solid dosage product, a plurality of representative dosing units thereof, a fraction of a representative dosing unit (e.g., a portion of granules of a disintegrated tablet), a subpart thereof (e.g., granules of a capsule without hard gelatin shell of the capsule), or an intermediate product of production thereof (e.g., granules of a tablet prior to tableting). The term is not limited to a physical sample but in scope of meaning embraces a sample composed from different but equivalent samples each providing a portion of the data needed for construction of, e.g., an r(M) function for the composed sample.

The term “solid”, as used herein, when context of use suggests the use as an adjective, denotes comprising a particulate or having the property of a particulate. When context of use suggests a noun, the term denotes a particulate or a plurality of particulates.

The term “dissolution environment”, as used herein, denotes a space containing a liquid, i.e., a dissolution medium, in which a solid dissolves.

The term “dissolution process”, as used herein, denotes an event of dissolution of a solid in a dissolution medium in a dissolution environment, over a duration of (dissolution) time.

The term “dissolution condition”, as used herein, denotes a collective combination of fluid mechanical and/or physicochemical characteristics of a dissolution medium in a dissolution environment, or of a dissolution process.

A combination of fluid mechanical characteristics of a dissolution medium in a dissolution environment or of a dissolution process may sometimes be called a “hydrodynamic dissolution condition” of the dissolution environment or process, or, in short, “hydrodynamic condition” thereof, herein.

A combination of physicochemical characteristics of a dissolution medium in a dissolution environment or of a dissolution process may sometimes be called a “physicochemical dissolution condition” of the dissolution environment or process, or in short, “physicochemical condition” thereof, herein.

A hydrodynamic dissolution condition may be described in terms of fluid flow velocity and direction, or pressure gradient of the fluid, as variables of the hydrodynamic dissolution condition, among other variables.

A physicochemical dissolution condition may be described in terms of chemical composition of the dissolution medium, pH thereof, temperature thereof, density thereof, and viscosity thereof, as variables of the physicochemical dissolution condition, among other variables.

A dissolution environment, or the dissolution condition thereof, may be said to be “complex” if a variable of the dissolution condition is space-dependent (i.e. varies from one point or region of space to another at any given point of time), time-dependent (i.e. varies from one point or period of time to another at any given point of space), or dependent on a probability function (i.e., has a probability to be more than one value at any given point of time and any given point of space).

A dissolution process, or the dissolution condition thereof, may be said to be “complex” if a variable of the dissolution condition is time-dependent (i.e. varies from one point or period of time to another in the dissolution process), or dependent on a probability function (i.e., has a probability to be more than one value at any given point of time). The process and condition may be said to be “simple” if variables of the condition are neither time-dependent nor dependent on a probability function. In between complex and simple, the process and condition may be said to be “simpler”.

The term “in vivo”, as used herein, denotes in, or of, an original setting, especially a biological or natural environmental setting, such as the intralumen (lumenal) environmental setting of the GI tract of a live human.

The term “in vitro”, as used herein, denotes in, or of, an artificially constructed and experimentally simulative setting, such as a laboratory dissolution test setting in a laboratory dissolution testing apparatus.

A dissolution condition may be said to be a “component dissolution condition” of a dissolution process if the dissolution condition has a probability to be found in the dissolution process at a given point of time thereof, or during a given period thereof, at a given point of space, or in a given region of the space, of a dissolution environment in which the dissolution process of a solid takes place.

In evaluating rate of dissolution of an ingredient of a solid dosage product or a sample thereof dissolving in a complex dissolution process, a preferred embodiment of method of the invention comprises a step of evaluating an r(M, t_{c}) function for the ingredient dissolving under each of a plurality of in vitro dissolution conditions, each member of the plurality of in vitro dissolution conditions simulating a component dissolution condition of the in vivo dissolution process. The preferred embodiment teaches an inventive use of an equation of the following general format, for linearly correlating differential rate of dissolution in a complex in vivo dissolution process with differential rates of dissolution determined or determinable under an in vitro dissolution condition:

$$R ( M , t ) = {\sum }_{i = 1}^{n} {η}_{i} \cdot {r}_{i} ( M , {t}_{c} , {t}_{i} ) + ɛ \qquad ( eq . 14 )$$

where R(M,t) denotes differential rate of dissolution of an ingredient of a solid dosage product or a sample thereof dissolving in a complex dissolution process, at a point of time t thereof, when cumulative mass of the ingredient dissolved from the solid dosage product or the sample thereof is M; i an integer representing a membership number of an i-th member of a plurality of n component dissolution conditions of the complex dissolution process, n being an integer ≧1 (greater than or equal to one); rᵢ(M, t_{c}, tᵢ) differential rate of dissolution of the ingredient dissolving from the solid dosage product or the sample thereof under an in vitro dissolution condition simulating an i-th member of the plurality of n component dissolution conditions, the solid dosage product or the sample thereof having a cumulative mass, M, of the ingredient dissolved therefrom and had a dissolution medium contact time t_{c} effectively equal to t (while time for the ingredient to reach the cumulative mass dissolved M in an in vitro dissolution process being tᵢ, if dissolution condition of the in vitro process were to consist of only the i-th in vitro simulative dissolution condition); ηᵢ a coefficient of correlation between R(M,t) and rᵢ(M, t_{c}, tᵢ); ε an error term; and remaining symbols have their ordinary mathematical meanings. Equation (eq. 14) is hereinafter sometimes referred to as a “general form of IVIVC equation” of method of the present invention.

Considering, for a simple example, the dissolution of a single particulate of a solid dosage product in a complex in vivo dissolution process in the GI tract of a live human, let R(M,t) denote differential rate of dissolution of an ingredient dissolving from the particulate at a point of time t of the complex in vivo dissolution process, when cumulative mass of the ingredient dissolved from the particulate is M. Let i denote an integer representing a membership number of an i-th member of a plurality of n component dissolution conditions that may be found in the complex in vivo dissolution process, n being an integer ≧1. At the point of time t, the particulate is located at a point of space (or location) z in the GI tract, z being generally a function of t, representing a transit function z(t) for the particulate in the GI tract. Let pᵢ(z) denote a percent probability of finding an i-th member of the plurality of n component dissolution conditions at the point of space z (and time t). Let rᵢ(M, t_{c}, tᵢ) denote differential rate of dissolution of the ingredient dissolving from the particulate under an in vitro dissolution condition simulating an i-th member of the plurality of n component dissolution conditions, the particulate having had a cumulative mass, M, of the ingredient dissolved therefrom and a dissolution medium contact time t_{c} effectively equal to t (while time for the ingredient to reach the cumulative mass dissolved M in an in vitro dissolution process being tᵢ, if dissolution condition of the in vitro process were to consist of only the i-th in vitro simulative dissolution condition). The following equation is written and used in accordance with a preferred embodiment of method of the invention approximating R(M,t) by a probability weighted average of differential rates of dissolution of the ingredient determined under a plurality of n in vitro dissolution conditions each simulating a corresponding member of the plurality of n component dissolution conditions:

$$R ( M , t ) = {\sum }_{i = 1}^{n} {p}_{i} ( z ) \cdot {r}_{i} ( M , {t}_{c} , {t}_{i} ) + ɛ \qquad ( eq . 15 )$$

where each of the coefficients of correlation, in place of ηᵢ of equation (eq. 14), is simply a percent probability, pᵢ(z), of finding variables of in vivo dissolution condition falling within a range of variation represented by a corresponding (i-th) member of the plurality of n component dissolution conditions, in the complex in vivo dissolution process, at location z.

For a solid dosage product consisting of a plurality of particulates that transit through the GI tract as a single fraction, the single fraction dissolving under the complex in vivo dissolution condition of the GI tract in a complex in vivo dissolution process, equation (eq. 15) is written with modifications in definition of certain symbols, namely, replacing the single particulate with the single fraction and the point of space z with a region of space z, in accordance with a preferred embodiment of method of the invention.

In a case of a solid dosage product comprising a plurality of particulates that transit through the GI tract as several (i.e., N, N being an integer >1) fractions each at a different transit rate in an complex in vivo dissolution process, a modified equation (eq. 15) is written for each of the fractions replacing the single particulate with a fraction of the particulates in definition of symbols, and point of space z with region of space z, in accordance with a preferred embodiment of method of the invention. Assigning a subscript j to each symbol that represents a property of a j-th fraction of the particulates, the modified equation (eq. 15) is written in the following form:

$${R}_{j} ( {M}_{j} , t ) = {\sum }_{i = 1}^{n} {p}_{i} ( {z}_{j} ) \cdot {r}_{ij} ( {M}_{j} , {t}_{c} , {t}_{ij} ) + {ɛ}_{j} \qquad ( eq . 16 )$$

Differential rate of dissolution of the ingredient dissolving from the solid dosage product in the GI tract is computed as:

$$R ( M , t ) = {\sum }_{j = 1}^{N} {R}_{j} ( {M}_{j} , t ) \qquad ( eq . 17 )$$

where R(M,t) denotes differential rate of dissolution of the ingredient dissolving from the solid dosage product in the GI tract at a point of time t when cumulative mass dissolved from the solid dosage product is

$$M = {\sum }_{j = 1}^{N} {M}_{j} ,$$

and remaining symbols have same meanings as in equation (eq. 16).

In a case of a solid dosage product comprising a plurality of particulates that transit through the GI tract as several (N) fractions each at a different transit rate and each initially (i.e., at time of fractionation) consisting of a composition sufficiently similar to another qualitatively, representing initially a quantitative fraction of the plurality of particulates at a fraction number fⱼ=wⱼ/w₀ (for a j-th member of the several fractions, where wⱼ and w₀ denote initial mass of the ingredient of the j-th fraction and of the whole plurality of particulates, respectively), the following forms of equation (eq. 16) are used each in accordance with a preferred embodiment of method of the invention, incorporating equations (eq. 10) and (eq. 11), respectively:

$$\begin{matrix}{R}_{j} ( {M}_{j} , t ) = {\sum }_{i = 1}^{n} {p}_{i} ( {z}_{j} ) \cdot {f}_{j} \cdot {r}_{i} ( \frac{{M}_{j}}{{f}_{j}} , {t}_{c} , {t}_{ij} ) + {ɛ}_{j} , & ( eq . 18 ) \\ {R}_{j} ( {F}_{j} , t ) = {\sum }_{i = 1}^{n} {p}_{i} ( {z}_{j} ) \cdot {r}_{i} ( {F}_{j} , {t}_{c} , {t}_{ij} ) + {ɛ}_{j} & ( eq . 19 )\end{matrix}$$

and the following forms of equation (eq. 17):

$$\begin{matrix}R ( M , t ) = {\sum }_{j = 1}^{N} {\sum }_{i = 1}^{n} {p}_{i} ( {z}_{j} ) \cdot {f}_{j} \cdot {r}_{i} ( \frac{{M}_{j}}{{f}_{j}} , {t}_{c} , {t}_{ij} ) + ɛ , & ( eq . 20 ) \\ R ( F , t ) = {\sum }_{j = 1}^{N} {\sum }_{i = 1}^{n} {p}_{i} ( {z}_{j} ) \cdot {r}_{i} ( {F}_{j} , {t}_{c} , {t}_{ij} ) + ɛ & ( eq . 21 )\end{matrix}$$

where

$$ɛ = {\sum }_{j = 1}^{N} {ɛ}_{j} ; {r}_{i} ( \frac{{M}_{j}}{{f}_{j}} , {t}_{c} , {t}_{ij} ) and {r}_{i} ( {F}_{j} , {t}_{c} , {t}_{ij} )$$

denote differential rate of dissolution of the ingredient of the solid dosage product under an in vitro dissolution condition simulating an i-th component dissolution condition, expressed with reference to absolute mass and percent mass dissolved therefrom, respectively, and a dissolution medium contact time of t_{c} effectively equal to t (and time for the ingredient to reach the cumulative mass dissolved, Mⱼ/fⱼ or Fⱼ, in an in vitro dissolution process being tᵢⱼ, if dissolution condition of the in vitro process were to consist of only the i-th dissolution condition); Rⱼ(Mⱼ,t) and Rⱼ(Fⱼ,t) denote differential rate of dissolution of the ingredient of a j-th fraction of the solid dosage product in the GI tract, expressed with reference to absolute mass and percent mass dissolved from the j-th fraction respectively, at a point of time t when cumulative mass of the ingredient dissolved therefrom is Mⱼ and Fⱼ, respectively; and other symbols are as defined either immediately above or in equations (eq. 16) and (eq. 17).

In each of the equations (eq. 14) to (eq. 21) above, each symbol that denotes a differential rate of dissolution, e.g., R(F,t) and rᵢ(Fⱼ,t_{c},tᵢⱼ) in equation (eq. 21), is shown with sub-symbols denoting both cumulative mass dissolved, e.g., F and Fⱼ, and time to reach the cumulative mass dissolved, e.g., t and tᵢⱼ, in a dissolution process, as or among variables of a function for the rate, in order to illustrate relationships between the time and the mass within a function, and between functions, in each of the equations. It is understood that, given a dissolution process, cumulative mass dissolved and time to reach the cumulative mass dissolved in the dissolution process has a fixed relationship (i.e., mutually dependent). Accordingly, when reference is made to a dissolution process, the symbol denoting differential rate of dissolution may be rewritten with either the mass or the time omitted, e.g., R(F,t)=R(t) and R(F,t)=R(F); and, rᵢ(Fⱼ,t_{c},tᵢⱼ)=rᵢ(t_{c},tᵢⱼ) and rᵢ(Fⱼ,t_{c},tᵢⱼ)=rᵢ(Fⱼ,t_{c}). In the latter case, with the reference to the dissolution process, t_{c}=tᵢⱼ dependent on Fⱼ (and vice versa), and thus, further, rᵢ(t_{c},tᵢⱼ)=rᵢ(tᵢⱼ), rᵢ(Fⱼ,t_{c})=rᵢ(Fⱼ), and rᵢ(Fⱼ,t_{c})=rᵢ(tᵢⱼ).

When reference is made to a dissolution condition, the sub-symbol for time of dissolution, e.g., tᵢⱼ, of a dissolution process is irrelevant, and a symbol denoting a differential rate of dissolution, e.g., rᵢ(Fⱼ,t_{c},tᵢⱼ), under a given dissolution condition may be rewritten with the time of dissolution process omitted, e.g., rᵢ(Fⱼ,t_{c},tᵢⱼ)=rᵢ(Fⱼ,t_{c}), in equations (eq. 14) to (eq. 21) above.

Equations (eq. 14) to (eq. 21) above may be more easily understood if a rate function, e.g., rᵢ(F,t_{c},tᵢ), for an ingredient of a solid dosage product dissolving under a given dissolution condition, e.g., an in vitro dissolution condition simulating an i-th component dissolution condition of an in vivo dissolution process, is viewed as a 3-D surface. Any in vivo dissolution process comprising dissolution of the ingredient of the solid dosage product under the given dissolution condition, at a point of time t of the in vivo dissolution process and a degree M of the ingredient dissolved, may be viewed with a reference to a point on the 3-D surface, at M and t_{c}=t.

It is noted that, where an r(M,t_{c}) function, or a portion thereof, is substantially independent of t_{c}, the r(M,t_{c}) function, or the portion thereof, is essentially characterized by a single r(M) function, or a corresponding portion thereof, respectively. In such a case, the term “t_{c} effectively equal to t”, as used herein, means t_{c} set at a value that effectively refers to a value of r substantially equal to the value of r at t_{c} equal to t on a 3-D r(M,t_{c}) surface, given the M. For example, in FIG. 1B, where the portion of an envisioned 3-D r(M,t_{c}) surface passing through curves 19 and 20 shows substantial independence of r on t_{c}, e.g., after 50% cumulative mass is dissolved, t_{c} effectively equal to t means any t_{c} under the 3-D r(M,t_{c}) surface given the M. In the present disclosure, “t_{c} effectively equal to t” is sometimes expressed as “t_{c}=t”.

Further, it helps to view a rate function, e.g., R(M,t), for a complex dissolution process that comprises different component dissolution conditions corresponding to different 3-D r(M,t_{c}) surfaces in a 3-D r-M-t_{c} space, as a 3-D curve in the 3-D r-M-t_{c} space, formed by weighted averaging of value of the 3-D r(M,t_{c}) surfaces at different M and different t_{c}=t in accordance with an IVIVC equation of the general form of equation (eq. 14) above.

Thus, an R(M,t) function of a dissolution process comprising only one component dissolution condition may be viewed as a 3-D curve located on an r(M,t_{c}) surface for the component dissolution condition, while an R(M,t) function of a dissolution process comprising different component dissolution conditions represented by different r(M,t_{c}) surfaces in a 3-D r-M-t_{c} space is associated with a 3-D curve that is located in space between or among the different r(M,t_{c}) surfaces inclusive of the surfaces.

A characteristic feature of IVIVC in accordance with the present inventive method is that a correlation is made in differential rates of dissolution between an in vivo dissolution process and an in vitro dissolution condition, i.e., the use of, e.g., equation (eq. 14). An in vivo dissolution rate function computed from, e.g., equation (eq. 14), based on such a correlation, may then be provided as an input to an absorption model for, e.g., computation of absorption rate and extent based on differential equations governing an in vivo absorption process. Alternatively, a correlation equation of the general form of equation (eq. 14) may be incorporated directly into a physiologically-based pharmacokinetic (PBPK) model modeling or simulating absorption, distribution, metabolism, and elimination (ADME) of an active ingredient in an in vivo system, and correlation made between an in vitro dissolution rate function and an in vivo metric such as blood concentration-time profile. See further disclosure hereinafter. This is in contrast to traditional methods of IVIVC that empirically correlate cumulative mass dissolved with cumulative mass absorbed, between an in vitro dissolution process and an in vivo absorption process, assuming (but without mechanistic or theoretical ground, and indeed, contrary thereto. See further disclosure hereinafter) existence of a simple empirical relationship therebetween for different processes and products.

In each of the equations (eq. 14), (eq. 15), (eq. 16), (eq. 18), and (eq. 19), in accordance with the teaching of the particular embodiments of method of the invention, linear correlation of dissolution rates is made at identical points of cumulative mass (M, Mⱼ, Mⱼ/fⱼ, or Fⱼ) of the ingredient dissolved, and t_{c}=t, while an in vitro process-dependent time (tᵢ or tᵢⱼ) is treated to be generally different from an in vivo process-dependent time (t).

In each of the equations (eq. 20) and (eq. 21) in the other particular embodiments of method of the invention, linear correlation of dissolution rates is made while both cumulative mass dissolved and time of dissolution are treated to be generally different between an in vitro process and the in vivo process. This is in contrast to traditional methods, which popularly teach or assume identical tᵢ (or tᵢⱼ) and t at a given M in IVIVC, even when dissolution condition (including time-function thereof) of an in vitro dissolution process clearly differs from that of an in vivo dissolution process (compare, e.g., a USP type II continuously stirred in vitro hydrodynamic dissolution condition and a lumenal peristaltic in vivo GI hydrodynamic dissolution condition).

The error term ε in equation (eq. 14) is defined as difference between R(M,t) and

$${\sum }_{i = 1}^{n} {η}_{i} \cdot {r}_{i} ( M , {t}_{c} , {t}_{i} ) ,$$

where t_{c}=t and ηᵢ is coefficient of correlation used for computation of R(M,t), ε accounting for dissolution of the ingredient under component dissolution conditions of the complex dissolution process that are not represented or simulated collectively by the plurality of in vitro dissolution conditions. In preferred embodiments of method of the invention where the plurality of in vitro dissolution conditions in combination adequately represents or simulates (i.e., is treated as an adequate simulation of) variation in values of variables of the complex dissolution condition, ε is small and omitted from the equation (i.e., treated as zero). In an equivalent manner, where an error term in each of the equations (eq. 15), (eq. 16), and (eq. 18) to (eq. 21) is considered negligible, the error term is omitted therefrom.

Other features of the inventive steps of evaluating differential rate of dissolution of an ingredient of a solid dosage product dissolving in a complex dissolution process, as a linear combination of rate functions determined under in vitro dissolution conditions simulating component dissolution conditions of the complex dissolution process, include:

(a.) various schemes are possible by which component dissolution conditions of a complex dissolution process may be identified, and a form of equation (eq. 14) written for use in accordance with a preferred embodiment of method of the invention;

(b.) a more complex dissolution condition may be treated as a combination or a mixture of a plurality of less complex component dissolution conditions (until a component dissolution condition is a simple dissolution condition); and

(c.) given a plurality of rate functions rᵢ(M, t_{c}) and a plurality of corresponding correlation coefficients ηᵢ, there is defined a dissolution rate curve R(M,t) in accordance with a form of equation (eq. 14) for a dissolution process (simulative or real).

Disclosures above teach a principal of separation of variables in accordance with a preferred embodiment of method of the invention. The principal of separation of variables may be more readily understood if a linear relationship conforming to the mathematical expression of equation (eq. 14) is viewed as a matrix equation. For example, re-write IVIVC equation (eq. 14) as follows:
R(M,t)=η×r+ε (eq. 22)
where η denotes a row matrix, the elements of which consist of ηᵢ (i=1, 2, . . . , n) defined in equation (eq. 14), i.e., η={η₁, η₂, . . . , ηᵢ, . . . , ηₙ},
r a column matrix, the elements of which consist of rᵢ(M, t_{c}, tᵢ) (i=1, 2, . . . , n) defined also in equation (eq. 14), i.e.,

$$r = \{ \begin{matrix}{r}_{1} ( M , {t}_{c} , {t}_{1} ) \\ {r}_{2} ( M , {t}_{c} , {t}_{2} ) \\ ⋮ \\ {r}_{i} ( M , {t}_{c} , {t}_{i} ) \\ ⋮ \\ {r}_{n} ( M , {t}_{c} , {t}_{n} )\end{matrix} \} ,$$

and remaining symbols are either as defined in equation (eq. 14) or have their ordinary mathematical meanings. It is seen that rate of dissolution, R(M,t), of an ingredient of a solid dosage product dissolving in a complex dissolution process, is essentially a product of multiplication of two matrices, i.e., η and r. It will be understood from the following deductive reasoning that the two matrices represent two substantially independent factors of a complex dissolution process.

Each element, rᵢ(M, t_{c}, tᵢ), of the matrix r represents a rate function for dissolution of the ingredient under a given dissolution condition, at different degrees of dissolution of the ingredient and different dissolution medium contact times with the solid dosage product. As such, the matrix r represents a property of dissolution of the ingredient, independent of a dissolution process. See various descriptions of rᵢ(M, t_{c}, tᵢ) functions hereinabove.

Each element, ηᵢ, of the matrix η is a coefficient of correlation, which, in general, has a form of a probability, e.g., pᵢ(z), of finding a particulate, a plurality of particulates, or a fraction of particulates (herein sometimes, generically, “a dissolving solid”), dissolving under a given dissolution condition at a given location, i.e., z, of a dissolution environment, or is a function of the probability. See, e.g., descriptions of equations (eq. 15) to (eq. 21) hereinabove. See also further disclosures hereinafter. Given a transit function, i.e., z(t), for a dissolving solid in a dissolution environment, a probability, e.g., pᵢ(z), essentially defines, statistically, local dissolution condition imposed on the dissolving solid, at location z of the dissolution environment and time t in the dissolution process. Accordingly, the matrix η represents a property of the dissolution environment, more specifically local dissolution environment of the dissolution process, independent of a property of dissolution of a dissolving ingredient, given a transit function for the dissolving solid in the dissolution environment (if spatial transit therein is a significant part of the dissolution process, e.g., in a lumenal dissolution environment along the GI tract of a live human).

An advantage of applying the principal of separation of variables in accordance with a preferred embodiment of method of the invention is that a complex dissolution process in a complex dissolution environment in vivo may now be studied under less complex, more easily controlled conditions, or as less complex, more easily solvable problems, in more accessible (e.g., in vitro) environments. Each of the conditions may be controlled independently from another, and each of the problems (e.g., IVIVC model η and r-M functions) independently studied.

The term “discrete settlement hydrodynamic dissolution condition”, as used herein, denotes a hydrodynamic dissolution condition imposed on a dissolving particulate as the particulate is let to settle under a net gravity or floatation force acting thereon, from one resting position to another resting position, through a static column of dissolution medium.

The term “resting position”, as used herein, denotes a position on a physical wall or surface, the physical wall or surface defining a boundary of a dissolution environment, against which wall or surface a particulate rests as gravity, buoyancy, and any counter forces acting thereon are balanced out to cause the particulate to remain in a still position.

The term “discrete fluidization and settlement hydrodynamic dissolution condition”, as used herein, denotes a hydrodynamic dissolution condition imposed on a dissolving particulate as the particulate is fluidized from a resting position, under a vertical component of a drag force created by a local dissolution medium flow, the vertical component of the drag force overcoming all other forces (i.e., net gravity or buoyancy force) acting on the particulate, and the particulate is then allowed to settle, under a reduced or a diminished vertical component of the drag force and therefore a net gravity or buoyancy force, to a resting position.

The term “pressure-sensitive packed bed hydrodynamic dissolution condition”, as used herein, denotes a hydrodynamic dissolution condition imposed on a dissolving particulate embedded in a bed of particulates through which a flow of dissolution medium passes under a given pressure gradient.

The term “flow-sensitive fixed position hydrodynamic dissolution condition”, as used herein, denotes a hydrodynamic dissolution condition imposed on a dissolving particulate affixed to a position, while a flow of dissolution medium passes by at a given local velocity without causing the particulate to move along with the flow of dissolution medium.

The term “settling”, as used herein, has a broad meaning and denotes moving (of a particulate) under a net gravity force, or under a net buoyancy force, in a column of dissolution medium. The settling under a net gravity force is sometimes called herein “falling” and the settling under a net buoyancy force is sometimes called herein “rising”.

The term “fluidizing”, as used herein, denotes causing (a particulate) to move, from a resting position, in a direction of local dissolution medium flow, under a net drag force created thereby.

The term “local velocity of dissolution medium flow”, as used herein, denotes velocity of movement of a dissolution medium immediately beyond a boundary (or transition) layer between surface of a particulate and bulk of the dissolution medium, the boundary layer being a thin film of dissolution medium surrounding the particulate, through which velocity of movement of dissolution medium transits to velocity of movement, if any, of the particulate.

The term “relative local velocity of dissolution medium flow”, as used herein, denotes local velocity of dissolution medium flow with regard to a particulate, subtracted by velocity of movement of the particulate (i.e., local velocity of dissolution medium flow relative to movement of the particulate).

The term “vertical velocity of fluidization”, as used herein, denotes a minimum vertical component of local velocity of dissolution medium flow, that is required to cause a freely standing particulate to have a vertical component of fluidization.

The term “linear vertical distance of local dissolution medium flow (per unit time)”, as used herein, denotes a distance of movement (per unit time) of an imaginary fluid particle of a dissolution medium, along a vertical path at a velocity equal to the vertical component of a local velocity of the dissolution medium (with regard to a dissolving particulate).

The terms “settlement”, “settle”, and “settled”, as used herein, are noun, verb, and past tense forms, respectively, of the term “settling”.

The terms “fluidization”, “fluidize”, and “fluidized”, as used herein, are noun, verb, and past tense forms, respectively, of the term “fluidizing”.

In a preferred embodiment of method of the invention in evaluating rate of dissolution of a solid dosage product, a complex in vivo dissolution process in the GI tract of a live human is treated as one comprising discrete fluidization and settlement hydrodynamic dissolution conditions as component dissolution conditions. Each of the discrete fluidization and settlement hydrodynamic dissolution conditions is simulated under an in vitro discrete fluidization and settlement hydrodynamic dissolution condition. Rates of dissolution measured under the in vitro discrete fluidization and settlement hydrodynamic dissolution condition provide an r(M,t_{c}) function having values over a range of t_{c} that covers an entire range of duration of time t of an in vivo dissolution process. The following form of equation (eq. 14) is used for linear correlation of in vivo and in vitro rates of dissolution:
R(M,t)=η_{d}(z)·r_{d}(M,t_{c})+ε_{d} (eq. 23)
where R(M,t) denotes rate of dissolution of an ingredient of the solid dosage product dissolving in the in vivo dissolution process in the GI tract, at time t and cumulative mass of the ingredient dissolved M; η_{d}(z) a GI location (z) specific correlation coefficient for correlation between R(M,t) and r_{d}(M,t_{c}); r_{d}(M,t_{c}) the r(M,t_{c}) rate function for the ingredient of the solid dosage product, determined under the in vitro discrete fluidization and settlement hydrodynamic dissolution condition, and having value at M and t_{c}=t (subscript d indicates discrete fluidization and settlement hydrodynamic dissolution condition); ε_{d} an error term accounting for in vivo dissolution conditions not completely or accurately simulated by the in vitro discrete fluidization and settlement hydrodynamic dissolution condition; and other symbols have their ordinary mathematical meanings.

The preferred embodiment takes advantage of a theory developed by the applicant, for describing dissolution of a solid dosage product in the GI tract of a live human. In accordance with the theory, which is summarily presented below as one treatment of description of GI dissolution and not intended to be an only treatment thereof in embodying method of the invention (see another treatment hereinafter):

(a.) Local flow of dissolution medium (i.e., gastrointestinal fluid), with regard to a given particulate of a solid dosage product dissolving in the GI tract of a live human, is cyclic because of a peristaltic nature of GI motility, a cyclic local flow resulting in a particulate being alternately in a fluidized state and a settled state, as the particulate ventures through the GI tract and dissolves therein;

(b.) Each interval of time between a point at which a particulate is fluidized and a next point at which the particulate is again fluidized forms a cycle of a discrete fluidization and settlement hydrodynamic dissolution condition, duration of time of a dissolution process in the GI tract consisting essentially of a time series of such cycles;

(c.) A cycle of discrete fluidization and settlement hydrodynamic dissolution condition comprises a fluidizing period, a settling period, and a resting period, dissolution of a particulate during the resting period (i.e., in a settled state) being negligible, and significant only in the fluidizing and the settling periods (i.e., in a fluidized state);

(d.) While global hydrodynamic dissolution condition in the GI tract may be highly complex, local hydrodynamic dissolution condition with regard to a particulate dissolving in a fluidized state is essentially constant, characterized by a relative local velocity of dissolution medium flow determined by vertical velocity of fluidization Vᵥ of the particulate, an essentially constant local hydrodynamic dissolution condition causing the particulate to dissolve at a rate essentially independent of a changing global hydrodynamic dissolution condition at any time the particulate is in a fluidized state;

(e.) Local dissolution medium flow during a cycle of discrete fluidization and settlement hydrodynamic dissolution condition with regard to a particulate having a given vertical velocity of fluidization Vᵥ, the particulate at time t having transited to region z in the GI tract, following a transit function z(t), is characterized by a linear vertical distance D(z) (D expressed as a function of z) or D(t) (D expressed as a function of t, related to D(z) by the transit function for the particulate) of the local dissolution medium flow, per unit time, given by the following deductively derived equation:

$$D ( z ) or D ( t ) = \frac{{\int }_{{t}_{1}}^{{t}_{f}} {U}_{v} \cdot ⅆ t}{{t}_{2} - {t}_{1}} \qquad ( eq . 24 )$$

where Uᵥ denotes vertical velocity of local dissolution medium flow with regard to a particulate following the transit function z(t), t₁ time at which a cycle of discrete fluidization and settlement hydrodynamic dissolution condition begins (i.e., the point at which the particulate is fluidized), t₂ time at which the cycle ends (i.e., the point at which the particulate is again fluidized, which is also the point at which a next cycle begins), t_{f} time at which fluidized state ends and settled state begins within the cycle, t being in the range of t₁ to t₂, and other symbols either are as defined above or have their ordinary mathematical meanings;

(f.) Probability, p_{f}(z) or p_{f}(t), of finding a particulate dissolving in a fluidized state at time t and region z, the particulate having the given vertical velocity of fluidization and following the transit function z(t), is theoretically related to D(z) or D(t), respectively, by the following deductively derived equations:

$${p}_{f} ( z ) = \frac{D ( z )}{{V}_{v}} and {p}_{f} ( t ) = \frac{D ( t )}{{V}_{v}} \qquad ( eq . 25 )$$

(g.) Particulates having a same vertical velocity of fluidization, and following a same transit function in the GI tract, are subjected to a linear vertical distance of local dissolution medium flow per unit time statistically the same among the particulates;

(h.) Given an in vitro dissolution process comprising an in vitro discrete fluidization and settlement hydrodynamic dissolution condition, under which r_{d}(M,t_{c}) of equation (eq. 23) is determined, dᵥ replaces D(z) and D(t) in an equation equivalent to equation (eq. 24), for the in vitro discrete fluidization and settlement hydrodynamic dissolution condition;

(i.) In a case of a solid dosage product consisting of a single dissolving particulate, or a plurality of dissolving particulates transiting as one fraction and subjected to statistically same D(z), η_{d}(z) in equation (eq. 23) is theoretically the ratio D(z)/dᵥ, corrected by any factor that may be necessary due to difference in physicochemical properties of dissolution medium between the in vitro and the in vivo dissolution conditions, that may linearly affect rates of dissolution (by, e.g., a change in solubility of the dissolving ingredient);

(j.) Where particulates of a solid dosage product transit in the GI tract as one fraction but different vertical velocities of fluidization subject the particulates to statistically different D(z), dᵥ under the in vitro dissolution condition may be so controlled that a substantially same ratio of D(z)/dᵥ is maintained for particulates having the different vertical velocities of fluidization, and η_{d}(Z) is theoretically equal to D(z)/dᵥ, corrected by any factor that may be necessary due to difference in physicochemical properties of dissolution medium between the in vitro and the in vivo dissolution conditions; and

(k.) Given dᵥ, η_{d}(Z)=D(z)/dᵥ in equation (eq. 23) is a property of the GI tract and the transit function z(t), because D(z) is. Alternatively, replacing r_{d}(M,t_{c}) in equation (eq. 23) with r_{d}(M,t_{c}) divided by dᵥ, i.e., mass of the ingredient dissolved per unit linear vertical distance of local dissolution medium flow, η_{d}(z) is directly D(z).

Replacing D(z), dᵥ, η_{d}(Z), and r_{d}(M,t_{c}) with H(z), hᵥ, ηₛ(z), and rₛ(M,t_{c}), respectively, provides equations similar to (eq. 23) and (eq. 25), that apply to a discrete settlement hydrodynamic dissolution condition, where H(z) and hᵥ are linear vertical distance of settlement per unit time in vivo and in vitro, respectively, rₛ(M,t_{c}) the r(M,t_{c}) function determined in vitro under a discrete settlement hydrodynamic dissolution condition (of hᵥ), and ηₛ(z)=H(z)/hᵥ.

In another preferred embodiment of method of the invention, a complex in vivo dissolution process in the complex, peristaltic, in vivo lumenal environment of the GI tract is treated as a dissolution process further comprising pressure-sensitive packed bed hydrodynamic conditions as component dissolution conditions. The pressure-sensitive packed bed hydrodynamic conditions are simulated in vitro under an in vitro pressure-sensitive packed bed hydrodynamic dissolution condition at one or more head pressures. At several head pressures, the following form of equation (eq. 14) is used:

$$R ( M , t ) = {η}_{d} ( z ) \cdot {r}_{d} ( M , {t}_{c} ) + {\sum }_{p = 1}^{n} {η}_{p} ( z ) \cdot {r}_{p} ( M , {t}_{c} ) + {ɛ}_{dp} \qquad ( eq . 26 )$$

where ηₚ(z) denotes a GI location (z) specific correlation coefficient for correlation between R(M,t) and rₚ(M,t_{c}); rₚ(M,tₓ) the r(M,t_{c}) function for the ingredient dissolving from the plurality of particulates, determined under the in vitro pressure-sensitive packed bed hydrodynamic dissolution condition at a p-th head pressure, and having a value at M and t_{c}=t; ε_{dp} an error term accounting for in vivo dissolution conditions not completely or accurately simulated by the combination of in vitro discrete fluidization and settlement hydrodynamic dissolution condition, and in vitro pressure-sensitive packed bed hydrodynamic dissolution condition; and other symbols are as defined in equation (eq. 23).

Where the r(M,t_{c}) function under the pressure-sensitive packed bed hydrodynamic dissolution condition at one head pressure is linearly correlated with the function at another, equation (eq. 26) has the following simplified form:
R(M,t)=η_{d}(z)·r_{d}(M,t_{c})+ηₚ(z)·rₚ(M,t_{c})+ε_{dp} (eq. 27)
where rₚ(M,t_{c}) is now the r(M,t_{c}) function determined at a given head pressure, and ηₚ(z) a GI location(z)-specific correlation coefficient for correlation between R(M,t) and rₚ(M,t_{c}).

The preferred embodiment comprising the use of equation (eq. 26) or (eq. 27) takes advantage of an expanded theory (non-limiting) developed by the applicant, the expanded theory taking into consideration of dissolution of a particulate under a pressure-sensitive packed bed hydrodynamic dissolution condition.

In accordance with the expanded theory, a pressure-sensitive packed bed hydrodynamic dissolution (in vitro or in vivo) is characterized by a plurality of features, including: (a.) shape of a packed bed; and (b.) pressure gradient of dissolution medium in the packed bed. The following deductively derived equation theoretically describes factors contributing to rate of dissolution of a plurality of particulates dissolving under a pressure-sensitive packed bed hydrodynamic dissolution condition:

$${r}_{p} ( M , {t}_{c} ) = {C}_{0} \cdot ω \cdot \int {\int }_{A} Δ P \cdot ( 1 - {ⅇ}^{- \frac{D \cdot S}{Δ P \cdot ω \cdot h } \cdot \frac{L}{V}} ) \cdot ⅆ A \qquad ( eq . 28 )$$

where C₀ denotes solubility of the dissolving ingredient; ω specific hydraulic conductivity of the plurality of particulates; ΔP head pressure along a given flow line through the pile; D diffusion coefficient of the dissolving ingredient dissolved in the dissolution medium; S surface area of the dissolving ingredient exposed to dissolution medium; A surface area of the pile where dissolution medium enters the pile; L length of the given flow line; V volume of the pile; h thickness of a boundary layer of a dissolving particulate; and other symbols either are as defined above or have their ordinary mathematical meanings. It is understood that ω, S, h, A, L, and V each may be a function of M and t_{c}, and ΔP a function of GI location z as well as the given flow line.

For a plurality of particulates packed into a bed of a cylindrical shape (e.g., in an in vitro dissolution test), the following special form of equation (eq. 28) is deductively derived:

$${r}_{p} ( M , {t}_{c} ) = {C}_{0} \cdot ω \cdot Δ P \cdot ( 1 - {ⅇ}^{- \frac{D \cdot S}{Δ p \cdot ω \cdot h} \cdot \frac{1}{A}} ) \cdot A \qquad ( eq . 29 )$$

where ΔP and A now have well-defined values.

Equation (eq. 28) teaches that, when a solid dosage product comprises a plurality of particulates having a sufficiently low specific hydraulic conductivity ω (e.g., when the product contains certain polymeric excipients of high impedance to hydraulic flow of an aqueous dissolution medium), pressure gradient across a packed bed of the particulates being low (typically true in the GI tract of a mammal, else, the particulates would fluidize), and S being sufficiently high (e.g., at an early stage of a dissolution process) the exponential term in equation (eq. 28) approaches zero, and the integral term approximately becomes

$$\int {\int }_{A} Δ P \cdot ⅆ A ,$$

which is essentially a term dependent on dissolution environment, given a transit function of the particulates therein. In such a case, the rate function rₚ(M,t_{c}) is essentially a (linear) function of the specific hydraulic conductivity, and typically has low values.

In other preferred embodiments of method of the invention, a complex in vivo dissolution process in the GI tract of a live human may be treated as one comprising other or further component dissolution conditions including discrete settlement hydrodynamic dissolution condition and flow-sensitive fixed position hydrodynamic dissolution condition.

A discrete settlement hydrodynamic dissolution condition in the GI tract may occur when, e.g., a part of the lumenal wall of the GI tract against which a particulate rests moves in a direction that causes imbalance of forces acting on the particulate, and the particulate falls under a net gravity force through a static column of the GI fluid. Dissolution of a particulate under a discrete settlement hydrodynamic dissolution condition differs slightly from dissolution of the particulate in a fluidized state of a discrete fluidization and settlement hydrodynamic dissolution condition described herein before, in that relative local velocity of dissolution medium flow at the start of the settling is zero, accelerating therefrom towards a steady state velocity determined by the vertical velocity of fluidization of the particulate. The vertical velocity of fluidization may be closely approached only if the static column of dissolution medium through which the settling occurs is of a sufficient height, given a value of the vertical velocity of fluidization of the particulate.

A flow-sensitive fixed position hydrodynamic dissolution condition may occur when, e.g., a dissolving solid dosage product is affixed to a position and subjected to a local dissolution medium flow at a given flow rate. It may also occur when a wall on which a particulate rests pushes against a body of dissolution medium, and moves at a given speed.

In other in vivo dissolution environments, a dissolving solid dosage product may be affixed to a position, or dissolves in a fluid-scarce environment, and is subjected to no substantial fluidization. These other in vivo dissolution environments include, e.g., (a.) lumenal and capillary dissolution environment of respiratory tract of a live human, (b.) lumenal dissolution environment of rectal tract thereof, (c.) lumenal dissolution environment of vaginal tract thereof, (d.) dissolution environment of a patch or cream applied to a skin surface thereon, (e.) dissolution environment in a tissue thereof for a solid dosage product implanted or injected therein, and (f.) lumenal dissolution environment of a blood vessel thereof for a drug-eluting stent affixed to a position therein. In such a case, an in vivo dissolution process is treated, in a preferred embodiment of method of the invention, as one comprising only one or a combination of hydrodynamic dissolution conditions selected from a group consisting of pressure-sensitive packed bed hydrodynamic dissolution condition and flow-sensitive fixed position hydrodynamic dissolution condition.

In yet another preferred embodiment of method of the invention, the resting period of a cycle of discrete fluidization and settlement hydrodynamic dissolution condition, in vivo, is treated as one comprising a pressure-sensitive packed bed hydrodynamic dissolution condition, and simulated likewise in vitro. Thus, a resting period of an in vitro dissolution test comprises a period of dissolution medium flow at a given head pressure and a vertical velocity less than vertical velocity of fluidization of a plurality of particulates. Duration of the period of dissolution medium flow at the given head pressure is experimentally set to reflect a relative duration in vivo. An r_{d}(M,t_{c}) function, in, e.g., equation (eq. 23), determined in vitro, includes contribution from dissolution under the pressure-sensitive packed bed hydrodynamic dissolution condition.

While in many cases mathematical formulas may be deductively derived for computing a coefficient of correlation of an IVIVC equation of the general form of equation (eq. 14), in practice, a coefficient of correlation, e.g., η_{d}(z) in equation (eq. 23), is or has to be obtained from correlation of in vitro dissolution rate data and in vivo dissolution rate data. In a case of human medicine, the in vivo dissolution rate data cannot be directly determined, but may be computed from, e.g., clinically measurable plasma concentration-time profile data, via a PBPK model or method. Alternatively, the in vitro dissolution rate data may be fed into a PBPK model and a coefficient of correlation estimated by best matching of Monte Carlo simulation results with the clinically measurable results. An advantage of IVIVC in accordance with a preferred embodiment of method of the invention, e.g., the embodiment comprising the use of equation (eq. 23), over a method of the prior art, is that, an IVIVC model, established in a form of η, e.g., η_{d}(Z) of equation (eq. 23), may be valid across different products, as long as the different products are grossly similar in physical properties of particulates (e.g., gross size and vertical velocity of fluidization), so that any spatial transit in the in vivo dissolution environment (e.g., along the GI tract of a live human) is substantially same among the different products. An established IVIVC model (i.e., η), in combination with a PBPK model, allows direct computation of pharmacokinetic outcome of a solid dosage product, from in vitro dissolution testing results obtained on the solid dosage product. For a description of a PBPK model or method, see, e.g., U.S. Pat. No. 6,647,358 issued on Nov. 11, 2003 to Grass et al. See also, e.g., an in vivo absorption model and an in vivo PK model described by Yu et al (2001), AAPS PharmSci, 3(3): article 24. The cited references are incorporated herein in entirety.

In manufacturing a solid dosage pharmaceutical in controlling bioequivalence of a production batch (or product) to a target batch (or product), complete knowledge of η is not necessary and bioequivalence can be assured if in vitro dissolution rates (each as a said advantageous function) determined and evaluated in accordance with a preferred embodiment of method of the invention under each of the component preferably fundamental dissolution conditions directly and completely match those of the target batch (or product). This is because η represents the environmental factor, and the in vitro dissolution rates (each as a said advantageous function) the product factor, of rate of dissolution of a solid dosage pharmaceutical in an in vivo dissolution process. See the principal of separation of variables described herein above. Knowledge of η, however, allows evaluation of in vitro dissolution rates that do not directly and completely match those of the target, for effect on a simulated in vivo dissolution rate function computed by way of an IVIVC equation of the general form of equation (eq. 14). Knowledge of η also allows setting a quality control target range (specification) for evaluating the in vitro dissolution rates.

The present invention, accordingly, teaches innovative steps of a method of manufacturing a solid dosage product, to achieve desired or controlled rate of dissolution of an ingredient of the solid dosage product in an in vivo dissolution process. Referring to FIG. 2, the innovative steps of the method, in a preferred embodiment thereof, comprise a step (28) of determining and evaluating rate of dissolution of the ingredient, as a function of cumulative mass of the ingredient dissolved from the solid dosage product, under each of a plurality of in vitro dissolution conditions each simulating a component dissolution condition of the in vivo dissolution process. The evaluating comprises direct comparing of value of the rate of dissolution, with value of a predetermined target on the rate of dissolution, either continuously over a range of continuous value of the cumulative mass of the ingredient dissolved, or discretely at each of a plurality of discrete values or over each of a plurality of discrete ranges of values thereof. The predetermined target may comprise a predetermined quality control specification of allowable range of values, the specification being established from knowledge of a reference product or reference production batches, any knowledge of η with regard to the product or similar products, and any knowledge of PBPK with regard to the dissolving active ingredient. Based on whether the rate of dissolution, determined and evaluated as a said advantageous function, meets the predetermined target, a manufacturing decision may be made (29, FIG. 2), such as: (1.) acceptance or rejection of a production batch or lot of the solid dosage product; (2.) acceptance or rejection of a formulation or production process; and (3.) in a case where the rate of dissolution, as a said advantageous function, fails to meet the predetermined target, change, modification, or adjustment of variables of formulation and/or production process to effect a change in the rate of dissolution so that the rate of dissolution meets the predetermined target.

In an equivalent manner, other properties of dissolution, such as vertical velocity of fluidization and specific hydraulic conductivity, are also, preferably, determined as a function of at least the cumulative mass dissolved.

η being established, the evaluating (28, FIG. 2) comprises modeling and simulating rate of dissolution of the ingredient in the in vivo dissolution process, as a linear combination of rates of dissolution of the ingredient determined as said advantageous functions under said plurality of dissolution conditions. The rate of dissolution from the simulating, instead of directly the rate of dissolution determined in vitro, is compared to a predetermined target, to allow a manufacturing decision (29, FIG. 2) to be made accordingly. Alternatively, a PBPK model being established, the rate of dissolution from the simulating is fed to the PBPK model and the comparing is done between a simulated pharmacokinetic output and a predetermined target on a pharmacokinetic property (e.g., maximum systemic blood concentration, Cₘₐₓ, and area under the blood concentration-time curve, AUC) of the solid dosage product.

η being known, a direct experimental simulation of an in vivo dissolution process is performed in a single in vitro dissolution process in accordance with a preferred embodiment of method of the invention. The single in vitro dissolution process has a cyclic dissolution condition each cycle thereof consisting of a time-series of dissolution conditions each thereof simulating a component dissolution condition of the in vivo dissolution process for a relative duration to length of cycle reflecting probability of occurrence of the component dissolution condition at a point of time in the in vivo dissolution process equal to a point of time of the cycle in the in vitro dissolution process. The relative duration is determined by η.

Further, the evaluating comprises computation and comparison of AUrMC, mean differential rate of dissolution over mass, and mean differential time over mass.

It is a general feature of method and apparatus of the invention that, in evaluating and testing rate of dissolution of an ingredient of a solid dosage product, focus is placed on local dissolution condition for a dissolving particulate. Local dissolution condition, such as local velocity of dissolution medium flow, especially relative local velocity of dissolution medium flow, is treated as most critical of a dissolution environment, given a dissolution process therein. Alternatively stated, the method and the apparatus of the invention focus on local dissolution environment of a dissolution process, instead of global dissolution condition of a dissolution environment. By definition herein, all dissolution conditions of a dissolution process refer to local dissolution conditions of a local dissolution environment of a dissolving solid of the dissolution process.

A property equivalent to an algebraic transform of differential rate of dissolution may preferably be determined as a said advantageous function. Such a property may be, for example: (A.) mass of an ingredient dissolved per unit linear vertical distance of local dissolution medium flow of a discrete fluidization and settlement hydrodynamic dissolution condition; (B.) mass of an ingredient dissolved per unit linear vertical distance of settlement of a discrete settlement hydrodynamic dissolution condition; (C.) mass of an ingredient dissolved per unit linear distance of local dissolution medium flow of a fixed position hydrodynamic dissolution condition; (D.) mass of an ingredient dissolved per unit linear distance of dissolution medium flow through a packed bed of a pressure-sensitive packed bed hydrodynamic dissolution condition; (E.) differential rate of dissolution scaled by a factor chosen according to either an in vivo dissolution condition or its difference from a simulative in vitro dissolution condition; or (F.) any property equivalent to an algebraic transform of differential rate of dissolution wherein the algebraic transform comprises scaling by a factor chosen according to either an in vivo dissolution condition or its difference from a simulative in vitro dissolution condition. Such difference may include, for example, difference in: (A.) solubility of the ingredient in dissolution medium; (B.) linear vertical distance of local dissolution medium flow per cycle of a discrete fluidization and settlement hydrodynamic dissolution condition; (C.) linear vertical distance of settlement per cycle of a discrete settlement hydrodynamic dissolution condition; (D.) viscosity of dissolution medium; (E.) head pressure of a pressure sensitive packed bed hydrodynamic dissolution condition; and (F.) dissolution medium flow rate of a flow sensitive fixed position hydrodynamic dissolution condition. Properties equivalent to algebraic transform (e.g., division by dᵥ) of AUrMC and mean differential rate over mass will similarly occur as useful properties to those skilled in the art taught by the present disclosure.

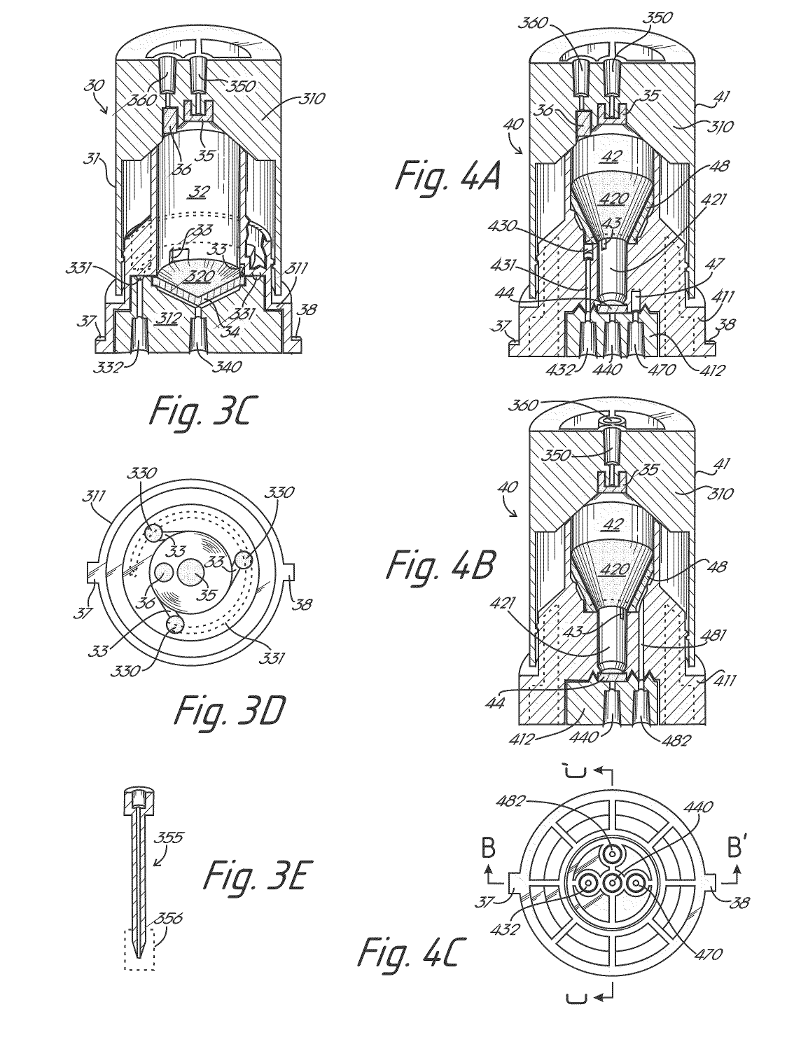

Referring to FIGS. 3A to 3D, first dissolution testing cell 30 is constructed for use in simulating, in an in vitro setting, one or more local hydrodynamic dissolution conditions of an in vivo dissolution process.

First dissolution testing cell 30 (FIGS. 3A to 3D) comprises: body 31 defining cell cavity 32; a plurality of tangentially oriented (hereinafter, tangential) openings consisting of three tangential openings to the cell cavity, two of which are visible at 33 in the front sectional view in FIG. 3C; and a conical filter 34 disposed at one end of the cell cavity, functioning as a bottom wall thereof and a bottom opening thereto. Cell cavity 32 has an axially symmetric shape with two ends and a side wall (FIG. 3C). Each of the tangential openings 33 is disposed on the side wall of the cell cavity 32 at one end thereof, and spaced apart substantially evenly one from another of the tangential openings. Each of the tangential openings (33) is further in a form of a nozzle having a generally rectangular orifice. A said nozzle is aimed in a direction substantially tangential to the (circular) side wall of the cell cavity (FIG. 3D, further description below) when viewed in a horizontal sectional view. The tangential openings 33 are in fluid communication with a fluid connection port 332, via a fluid distribution channel 331 (FIG. 3C). Bottom opening 34 is in fluid communication with another fluid connection port 340. Conical filter 34 defines a conical end 320 of cell cavity 32.

In the presently illustrated preferred embodiment, body 31 is formed as an assembly of three parts 310, 311, and 312 (FIG. 3C), each of which is formed of a plastic material by way of injection molding. Parts 311 and 312 are permanently affixed together by, in the present embodiment, solvent welding, and, in combination, form structural portion of a base half of first dissolution testing cell 30. Part 310 forms a cap therefor. Referenced at 315 in FIG. 3A are broken line illustrations indicating interior (hidden) rib structures customary to the art of injection molded plastics. Non-referenced rib structures visible in the bottom plan view of body 31 in FIG. 3B are apparent without further elaboration. 37 and 38 are structures for alignment use.

A full view of all of the three tangential openings 33 can be seen in the interior bottom plan view of body 31 in FIG. 3D (part 311 being visible therein and part 310 being hidden by part 311), after part 312 is removed, exposing bottom surface of part 311. Also visible in FIG. 3D are filters 330 (small, cylindrically shaped in the present embodiment) placed between nozzle (i.e. tangential opening) 33 and fluid distribution channel 331 (FIG. 3C). The latter, as illustrated in FIG. 3C, is formed between parts 311 and 312, as a groove formed into top surface of part 312. In FIG. 3D, position of the groove (i.e. fluid distribution channel) 331 relative to nozzles 33 is indicated by broken line illustration 331 superimposed on the interior bottom plan view.

In the presently illustrated preferred embodiment, a major portion of cell cavity 32 has the shape of a cylinder and the other end of cell cavity 32 has a conical shape in substantial mirror image to end 320.

In the presently illustrated preferred embodiment, first dissolution testing cell 30 further comprises a third opening 35 fitted with a filter and a fourth opening 36 fitted with a filter (FIGS. 3A, 3C and 3D). Third opening 35 is in fluid communication with fluid connection port 350 and fourth opening 36 fluid connection port 360.

A needle shaped sampling or extension probe 355 is illustrated in the front sectional view in FIG. 3E. The probe 355 may be used in place of third opening 35 (FIG. 3C) to allow extension of third opening 35 to tip 356 of the probe 355. Where desired, a filter may be fitted onto the tip 356 (FIG. 3E).

Accessories such as small beads for simulating food effect, and a rubber-surfaced piston to fit into 32, driven by pressurized inert gas from 350 and/or 360 to simulate a gut wall, may be included (not drawn).

Various advantageous features of first dissolution testing cell 30 will be seen from the following description of various modes in which first dissolution testing cell 30 may be used in accordance with embodiments of method of the invention for testing a sample of a solid dosage product in determining a property of dissolution of an ingredient thereof under one or more hydrodynamic dissolution conditions, especially a discrete fluidization and settlement hydrodynamic dissolution condition.

Referring to FIG. 3C, in a first mode of using first dissolution testing cell 30, a sample, such as a disintegrating, immediate release pharmaceutical tablet, having a disintegrated volume less than that which would reach to cover a tangential opening 33 upon particulates of the sample settling into, in a rotationally moving (see description below) column of dissolution medium, a cone-shaped pile on bottom wall of cell cavity 32, by gravity, is placed in cell cavity 32 of the base half of the first dissolution testing cell 30. Use of cap 310 is optional. Fluid conduits are connected to ports 332 and 340. Fluid flow via port 340 is stopped. A pulse of dissolution medium of a precisely known volume about three (3) to fifteen (15) preferably about five (5) to ten (10) times the disintegrated volume of the solid dosage sample is allowed to enter cell cavity 32 via nozzles 33, at a controlled flow rate and controlled velocity. The controlled flow rate may be a constant flow rate or a time-programmed, gradient flow rate, designed to provide a constant or a time-programmed, gradient rate of upward flow, respectively, in cell cavity 32 during the pulse. At a sufficiently high rate of the upward flow with vertical linear velocity greater than vertical velocity of fluidization of a particulate of the sample, the pulse forms a fluidizing period of a discrete fluidization and settlement hydrodynamic dissolution condition for the particulate. Vertical linear velocity of the upward flow and volume of the pulse, in combination, determine dᵥ (i.e., linear vertical distance of dissolution medium flow per unit time) for a particulate of a given vertical velocity of fluidization. At the end of the fluidizing period, i.e., as the vertical linear velocity of the pulse drops to zero, or gradually decreases following a gradient to less than vertical velocity of fluidization of a particulate, a period of settling follows. Thereafter, a period of no flow and thus zero vertical linear velocity of upward dissolution medium movement, or a low flow rate and thus less than the vertical velocity of fluidization, provides a resting period or a period of pressure-sensitive packed bed hydrodynamic dissolution condition, respectively. A sample of clear dissolution medium in cell cavity 32 is then taken via tangential opening 33 or probe 355 to determine amount of an ingredient dissolved therein for computation of differential rate of dissolution of the ingredient. Where concentration of a dissolved ingredient is within an appropriate range to allow direct and accurate fiber optic UV-Visible spectrophotometric determination in situ, a fiber optic UV-Visible cell may be installed in cell cavity 32, so long as the UV-Visible cell causes no significant disturbance of the discrete fluidization and settlement hydrodynamic dissolution condition.

It is noted that, at the end of the fluidizing period and the start of the settling period, dissolution medium in cell cavity 32 continues (but gradually decreases in angular velocity, and eventually reaches zero) its horizontally rotational movement because of momentum. The continued rotational movement causes particulates of the sample to settle into a cone-shaped pile on bottom wall of cell cavity 32.

Because part of a horizontally rotational movement in a circularly shaped cell cavity 32 turns into, or causes, a vertical component of dissolution medium flow, dᵥ cannot be calculated exactly from, but may be approximated by, height of water column of dissolution medium in cell cavity 32. Given a dissolution testing cell 30 and discrete fluidization and settlement dissolution condition, dᵥ can, however, be calibrated by a standard solid of a known vertical velocity of fluidization.

A second mode of use differs from the first mode of using first dissolution testing cell 30 in that, during a fluidizing period of a discrete fluidization and settlement hydrodynamic dissolution condition, dissolution medium enters cell cavity 32 via bottom opening 34 instead of tangential openings 33, and flow via tangential openings 33 during the period is stopped. This mode of use, while it allows testing of dissolution of a sample under a discrete fluidization and settlement hydrodynamic dissolution condition in accordance with an embodiment of method of the invention, is, however, experimentally found to suffer from noisy test results, presumably due to horizontally non-uniform upward flow and/or poor mixing of dissolution medium, in cell cavity 32, during and/or by the end, respectively, of a cycle of discrete fluidization and settlement. Accordingly, the second mode of use is not preferred.

A third mode of use differs from the first mode of using first dissolution testing cell 30 in that, during a fluidizing period, both ports 332 and 340 are connected to a common source of dissolution medium, which enters cell cavity 32 via both the tangential openings 33 and the bottom opening 34 at the same time during the fluidizing period.

A fourth mode of use differs from the third mode of use in that, during a fluidizing period, each of ports 332 and 340 is connected to an independently controlled source of dissolution medium, at an independently controlled flow rate. An independently controlled source of dissolution medium entering cell cavity 32 via tangential openings 33 by way of port 332 controls a tangential and horizontal component of velocity of movement of dissolution medium in cell cavity 32. An independently controlled source of dissolution medium entering cell cavity 32 via bottom opening 34 by way of port 340 controls a vertical component of the velocity. By way of independently controlling the components of velocity, a variety of local hydrodynamic dissolution conditions with a variety of local fluid velocities, controlled both in amplitude and in spatial direction, may be formed in cell cavity 32 of first dissolution testing cell 30.

A fifth mode of use allows first dissolution testing cell 30 to be of utility in determining rate of dissolution of an ingredient of a solid dosage product under a discrete settlement hydrodynamic dissolution condition. In such a mode of use, a sample is placed at bottom (320) of cell cavity 32, ports 340 and 360 are closed, and dissolution medium enters cell cavity 32 from tangential openings 33 by way of port 332, displacing trapped air out of cell cavity 32 via top opening 35 by way of port 350 until the dissolution medium fills up cell cavity 32. Port 350 is then closed. Reversing vertical orientation of cell 30 allows half of a cycle of discrete settlements, in which the sample settles by gravity towards the currently shown top end (filter 35, FIG. 3C). Reversing again and returning vertical orientation of cell 30 to the currently shown (FIG. 3C) allows the other half of the cycle in which the sample re-settles by gravity towards the currently shown bottom end (bottom filter 34, FIG. 3C). A sample of clear dissolution medium is withdrawn from cell cavity 32 via a choice or combination of tangential openings 33, third opening 35, and fourth opening 36, before dissolution medium in cell cavity 32 is completely drained out via bottom filter 34, readying the sample for a next cycle of testing. Concentration of an ingredient dissolved in the sample withdrawn is determined for computation of differential rate of dissolution of the ingredient during the cycle. The dissolution medium completely drained out of cell cavity 32 is accumulated in a cumulative vessel and combined with any dissolved amount of the ingredient during the dissolution test prior to the cycle. Mass of the ingredient dissolved in dissolution medium accumulated in the cumulative vessel is then determined for computation of cumulative mass of the ingredient dissolved as of a time during the cycle or thereabout (e.g., during, at the beginning, or at the end thereof).

A sixth mode of use allows first dissolution testing cell 30 to be of utility for determining rate of dissolution of an ingredient of a solid dosage product under a pressure-sensitive packed bed hydrodynamic dissolution condition of a low head pressure. In such a mode of using the cell, a sample is placed at bottom (320) of cell cavity 32, cap 310 is optional, port 340 is initially closed, a known volume of dissolution medium gently enters cell cavity 32 via tangential openings 33, as a stream of a controlled (low) flow rate, allowing the sample to maintain as a pile (i.e., a packed bed) on bottom wall of cell cavity 32. A sample of the dissolution medium in cell cavity 32 is taken via tangential openings 33 for determination of differential rate of dissolution before the dissolution medium is completely drained out of cell cavity 32 via bottom opening 34, readying the sample for a next cycle of testing. The dissolution medium completely drained out is accumulated for determination of cumulative mass dissolved.

By way of a time-programmed control of rates of flowing dissolution medium into cell cavity 32 via the tangential openings 33, the bottom opening 34, or a combination thereof, a time-programmed local hydrodynamic dissolution condition may be formed for experimentally simulating a time course of a complex hydrodynamic dissolution condition of a complex in vivo dissolution process.

A modified first mode of use further comprises, in a cycle of discrete fluidization and settlement, a pulse of dissolution medium of a known volume (about the volume of 320) entering cell cavity 32 via bottom filter 34 before the pulse of dissolution medium entering via nozzles 33.

It will, of course, be apparent to those skilled in the art, taught by the present disclosure, that more than one of the above described modes of use may be programmed into a single dissolution test as a time series, and more than one rate functions determined from the single test, each under a different dissolution condition of a single dissolution process.

While end wall of cell cavity 32 of first dissolution testing cell 30 illustrated in FIG. 3C have a conical shape in the presently shown embodiment of apparatus of the invention, in other embodiments, the end wall may have other shapes, such as flat, round, and flat or round with a central rise.

The data presented in FIGS. 1A and 1B were determined by using a prototype dissolution testing cell similar to first dissolution testing cell 30 (FIG. 3C), except that bottom of cell cavity (32) was flat, bottom filter (34) and associated fluid connection (340) absent, and one tangential opening with a circular nozzle in place of three (33) each with the rectangular nozzle. Diameter of cylindrically shaped cell cavity (32) of the prototype dissolution testing cell was 2.15 centimeters. Each cycle of discrete fluidization and settlement had duration of 2 minutes, except the first cycle. The first cycle in determining the curve 10 data had duration of 5 minutes and the curve 12 data 10 minutes. A beginning 3 seconds of each cycle consisted of a fluidizing period, and the remaining a settling and a resting period. A total volume of 8.04 milliliters of dissolution medium was delivered at a constant flow rate to the tangential nozzle during a fluidizing period, achieving a vertical velocity of dissolution medium flow in cell cavity 32 calculated at an average value of about 0.74 centimeter/second. Treating the longer duration of the first cycle as a combination of a regular cycle (i.e. one of the subsequent cycles) plus 3 minutes and 8 minutes of extra disintegration time under a static hydrodynamic condition for curve 10 and 12, respectively, dᵥ for each regular cycle is calculated at 1.1 centimeter/minute. Sampling of dissolved acetaminophen in each cycle was achieved by means of a probe (355, without filter tip 356) immediately before a next cycle began. Each sample of solution consisted of 8.04 milliliters except in the first cycle. The sample in the first cycle was about 7 milliliters (so there was about 1 milliliter of dead volume of solution in the cell cavity after each sampling). Each sample of solution was filtered (WHATMAN 0.45 micrometer GMF) immediately after sampling before being stored away for UV determination (within 12 hours). First 4 milliliters or so of a filtrate was discarded. Concentration of acetaminophen dissolved in each sample of solution was determined by UV at 242 nanometer. Mass dissolved during each cycle was computed as product of multiplication of the concentration, and volume (8.04 milliliters) of dissolution medium of each cycle. Dividing the mass by duration (2 minutes) of a cycle gives differential rate of dissolution during the cycle. Dividing the differential rate of dissolution by dᵥ gives mass of acetaminophen dissolved per unit linear vertical distance of local dissolution medium flow.

While in the FIG. 1A embodiments r(t) is experimentally determined, M(t) computed therefrom, and r(M) subsequently constructed from r(t) and M(t), it is preferred that, in other preferred embodiments (see, e.g., description of the fifth and sixth modes of using first dissolution testing cell 30 above), r and M are determined independently one from the other, pair-wise, at or about each point of a plurality of points of time representative of a dissolution process or dissolution condition, or averaged over each interval of a plurality of intervals of the time, each of the intervals being non-overlapping with another. The plurality of points of time or non-overlapping intervals being representative of the dissolution process, an r(M) function constructed directly from pair-wise experimentally determined values of r and M characterizes dissolution of an ingredient in the dissolution process. The plurality of points of time or non-overlapping intervals being all under a given dissolution condition, the r(M) function constructed characterizes dissolution under the given dissolution condition.

Referring now to FIGS. 4A to 4C, second dissolution testing cell 40 constructed in accordance with a preferred embodiment of apparatus of the invention comprises a same cap 310 (FIG. 4A) as first dissolution testing cell 30 (FIG. 3C), and differs therefrom in a base half (411 plus 412) of body 41 (FIGS. 4A and 4B). The base half (411 plus 412) of body 41 defines cell cavity 42, and comprises: first tangential opening 43 (FIGS. 4A and 4B); second tangential opening 47 (FIG. 4A); bottom filter 44; and side wall filter 48. Cell cavity 42 has an axially symmetric shape as in first dissolution testing cell 30, and differs therefrom in that it (42) comprises a truncated conical section 420 and a bottom cylindrical section 421. Side wall of truncated conical section 420 is defined by side wall filter 48. 48 is in fluid communication with fluid connection port 482 via passageway 481 (FIG. 4B), providing a side opening to cell cavity 42. First tangential opening 43 is in fluid communication with fluid connection port 432 via cylindrical filter housing 430 (the filter housed therein is not drawn in order to show the housing) and passageway 431 (FIG. 4A). Second tangential opening 47 is in fluid communication with fluid connection port 470 (FIG. 4A). Bottom filter 44 is in fluid communication with fluid connection port 440 (FIGS. 4A and 4B). As seen in FIGS. 4A and 4B, first tangential opening 43 is disposed at an upper end of cylindrical section 421. As seen in FIG. 4A, second tangential opening 47 is disposed at a lower end thereof. Each of the tangential openings 43 and 47 comprises a nozzle oriented tangentially to (circular) side wall of cylindrical section 421 and, when viewed top down, one in a one-hundred-eighty (180) degree rotational relationship to the other. Each nozzle provides a tangential opening to cell cavity 42. The bottom filter 44 provides a bottom opening thereto. In FIG. 4A, the nozzle of second tangential opening 47 is out of the cross-section plane and thus out of the cross-sectional view. Seen at 47 is more precisely a cylindrical filter housing of second tangential opening 47 visible in FIG. 4A (the filter housed is not drawn in order to show the housing), equivalent to housing 430 of first tangential opening 43.

Second dissolution testing cell 40 is advantageously constructed for use in testing rate of dissolution of a plurality of particulates under a discrete fluidization and settlement hydrodynamic dissolution condition in a manner similar to the second, third, fourth, fifth, and modified first modes of using first dissolution testing cell 30. In such a mode of use, a multi-particulate (e.g., powder) or a disintegrating solid dosage form (e.g., a disintegrating pharmaceutical tablet), or a sample thereof consisting of a plurality of particulates, having a disintegrated wet volume not to exceed the level of nozzle of tangential opening 43 when settled to bottom of cell cavity 42 by gravity, preferably about one half (½) to about two thirds (⅔) of volume of cylindrical section 421, is placed in the cell cavity 42 for testing.

Second dissolution testing cell 40 is advantageously constructed for use further in testing rate of dissolution of a plurality of particulates under a pressure-sensitive packed bed dissolution condition at a precisely measured head pressure (i.e. pressure drop across a packed bed), and for determining hydraulic conductivity or resistance of particulates. In such a use, fluid connection ports 360 and 350 are closed, cell cavity 42 is completely filled with dissolution medium (e.g., by way of side opening 48 and port 482, removing any trapped air from top opening 35 and port 350 before port 350 is closed), a differential pressure transducer is connected to fluid connection ports 470 and 432, a plurality of particulates allowed to settle, and be packed into a packed bed, in cylindrical section 421, port 482 connected to a dissolution medium supply, and port 440 allows dissolution medium to exit from cell cavity 42.

To test rate of dissolution of the plurality of particulates under a pressure-sensitive packed bed dissolution condition in accordance with one embodiment of method of the invention, dissolution medium is supplied through 482 and allowed to pass through the bed of particulates in cylindrical section 421 at a given or known flow rate, while pressure drop between tangential openings 43 and 47 is read. Concentration of an ingredient dissolved in dissolution medium exiting 440 is determined. Rate of dissolution rₚ(M,t_{c}) as a function of M and t_{c} is computed by:
rₚ(M,t_{c})=Q·C(M,t_{c}) (eq. 30)
where C(M,t_{c}) is concentration of dissolved ingredient in dissolution medium exiting 440, determined when cumulative mass dissolved is M and dissolution medium contact time is t_{c}; and Q volumetric flow rate of the dissolution medium exiting 440.

Specific hydraulic conductivity ω is computed by:

$$ω = \frac{A \cdot Q}{L \cdot Δ P} \qquad ( eq . 31 )$$

where A is cross-sectional area of cylindrical section 421; L height of sample packed therein; and ΔP pressure drop. L and ΔP may be determined as a function of M and t_{c}.

Specific hydraulic resistance σ is a reciprocal of specific hydraulic conductivity:
σ=1/ω (eq. 32)

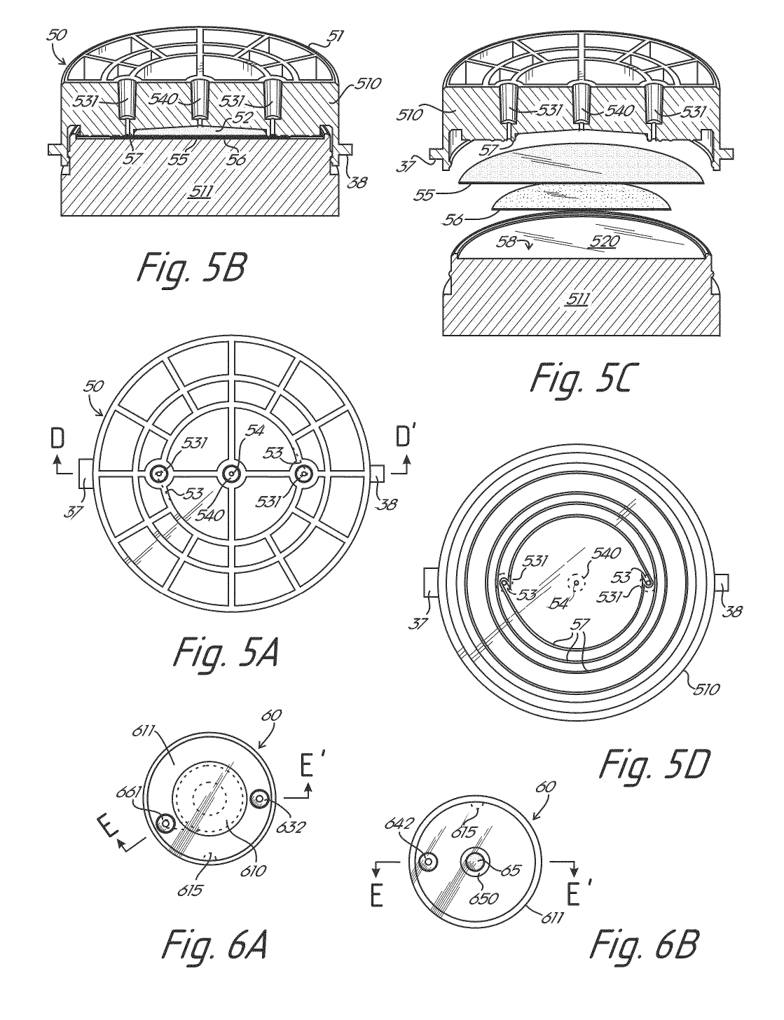

Referring now to FIGS. 5A to 5D, third dissolution testing cell 50 is constructed for use in testing rate of dissolution of a solid ingredient of a transdermal patch. Third dissolution testing cell 50 comprises: body 51 consisting of base 511 and cap 510 in an assemblage (front sectional view of the assemblage in FIG. 5B, and exploded view in FIG. 5C); cell cavity 52 defined by body 51 (FIG. 5B); two tangential openings 53 (as hidden structure shown by broken line illustration in top plan view in FIG. 5A and visible in bottom plan view of cap 510 in FIG. 5D) to cell cavity 52; a center opening 54 to same; and a membrane 55. Cell cavity 52 has an axially symmetrical shape and a minimal height, the shape being substantially represented by that of a disc. Each of the two tangential openings 53 is in a form of a nozzle disposed on side wall of the cell cavity 52 and oriented in a tangential direction thereto, one in a one hundred eighty (180) degree rotational relationship to the other. Each of the two tangential openings 53 is in fluid communication with a fluid connection port 531 (FIGS. 5A to 5D). The center opening 54 is in fluid communication with a fluid connection port 540. Membrane 55 may be a membrane filter of a known porosity and thickness, a skin tissue, a biological membrane, or an artificial membrane which simulates a skin tissue or biological membrane.

In an in vitro dissolution test using cell 50, transdermal patch 56 is patched to one side of membrane 55, the patched membrane is placed with the patch down on top of top surface 58 of base 511, and cap 510 is placed on top of the patched membrane, sandwiching same between cap 510 and base 511. Sufficient pressure is applied to enable cap 510 to press against base 511 allowing cavity 52 to be formed as a fluid-tight cavity sealed at peripheral edge by sealing rings (ridges formed on bottom surface of cap 510, FIG. 5D, indicated at 57). Dissolution medium is supplied at a known flow rate to cell cavity 52 via tangential openings 53 by way of fluid connection ports 531, and allowed to exit therefrom via center opening 54 by way of fluid connection port 540. Concentration of an ingredient dissolved in dissolution medium exiting from the cell cavity is determined, as is cumulative mass of the ingredient dissolved therein. Rate of dissolution as a function of, at least, cumulative mass dissolved is computed in a manner similar to that using equation (eq. 30).

Third dissolution testing cell 50 may also be used for testing rate of dissolution or release of such solid or semi-solid dosage forms as creams and pastes. In such a use, a sample such as a paste is applied (i.e., spread) as a thin layer evenly to top surface 58 of base 511, filling up shallow well 520 (lower cell cavity). Membrane 55 is placed on top of the thin layer and cap 510 on top of the membrane, closing the cell. Remaining steps are as in testing a patch described above.

A smaller version of the third dissolution testing cell for testing a small amount of material, e.g., a pure solid, will be apparent to those skilled in the art taught by the present disclosure. Surface 58 may be coated or lined with a water-proofing material (e.g., silicone). If lined, a venting hole may be provided on 58.

Turning now to FIGS. 6A to 6C, fourth dissolution testing cell 60 is constructed for use in determining vertical velocity of fluidization of a dissolving particulate and for determining rate of dissolution under a discrete settlement hydrodynamic dissolution condition. Fourth dissolution testing cell 60 comprises: body 61 consisting of base 610 and cap 611 in an assemblage (shown upside down in a reversed orientation in FIG. 6C); cell cavity 62 defined by body 61; first ring opening 63 to cell cavity 62; second ring opening 64 thereto; end opening 65 thereto; and tangential opening 66 thereto. Cell cavity 62 has a vertically elongated shape comprising a main section 620, an analytical section 621, and two end sections 623 and 625. In the presently shown and described preferred embodiment, each of the sections is axially symmetric with regard to a common axis of symmetry. End section 623 and 625 each comprise a tapered shape and a nipple space for centering and focusing a particulate sample. First ring opening 63 is in a form of a ring filter disposed at one end of main section 620 as shown (FIG. 6C). Second ring opening 64 is in a form of a ring filter disposed about one centimeter apart (along the axis of symmetry) from first ring opening 63. End opening 65 is in a form of a substantially disc-shaped filter disposed at one end of cell cavity 62, one side of the filter forming an end wall thereof. Tangential opening 66 is in a form of a nozzle disposed on side wall of the cell cavity 62, and oriented in a tangential direction thereto, at an end of main section 620 opposing the end at which first ring opening 63 is disposed. First ring opening 63 is in fluid communication with fluid connection port 632 via distribution channel 630. Second ring opening 64 is in fluid communication with fluid connection port 642 via distribution channel 640. End opening 65 is in fluid communication with fluid connection port 650. Tangential opening 66 is in fluid communication with fluid connection port 661. Section 620 in the presently shown and described embodiment has a length (along the axis of symmetry) of about twelve (12) centimeters, which in equivalent embodiments may be longer or shorter (for a particulate having a higher or lower vertical velocity of fluidization, respectively) to allow accurate measurement of time of settlement of a particulate settling from end 625.

In use, base 610 is placed in a (normal) vertical orientation reversed from that shown in FIG. 6C and a particulate sample placed in opening 625 thereof. Cap 611 is then placed on base 610 (i.e., base 610 is plugged into opening of cap 611), forming a fluid-tight combination therewith sealing at 67. While maintaining the normal vertical orientation, a stream of dissolution medium is directed to fluid connection port 661 from which it enters into cell cavity 62 via tangential opening 66. The stream of dissolution medium is allowed to fill up the volume of cell cavity 62 and displace any fluid content including trapped air therein. A stream of dissolution medium is then directed to fluid connection ports 632 and 642, entering cell cavity 62 via ring openings 63 and 64, leaving therefrom via end opening 65, and expelling any trapped air along the way. Thereafter, while maintaining, at a known flow rate, a steady flow of dissolution medium entering into cell cavity 62 via ring opening 63 and fluid connection port 632, and leaving therefrom via ring opening 64 and fluid connection port 642, thereby creating a cross flow in analytical section 621, the dissolution cell 60 is flipped over to a reversed vertical orientation (as is shown in FIG. 6C), allowing the particulate sample to settle by gravity in a column of dissolution medium in cell cavity 62. As a dissolving particulate reaches and passes analytical section 621, dissolution of the particulate occurs in the cross flow and solute therein is carried by the cross flow to fluid connection port 642. The latter (642) is connected to a detector allowing detection of the solute in the cross flow and thereby an amount of time the particulate took to settle from end section 625 to analytical section 621.

Reversing vertical orientation of cell 60 to the normal vertical orientation and allowing full settlement of undissolved particulates to end section 625 readies the sample for a next cycle of steps of displacing fluid content in cell cavity 62 and determining time of settlement of undissolved particulates thereby vertical velocity of fluidization. Determination of cumulative mass of an ingredient dissolved from the particulates in effluent from cell cavity 62 allows the time of settlement or vertical velocity of fluidization to be expressed as a function of, at least, cumulative mass of the ingredient dissolved.

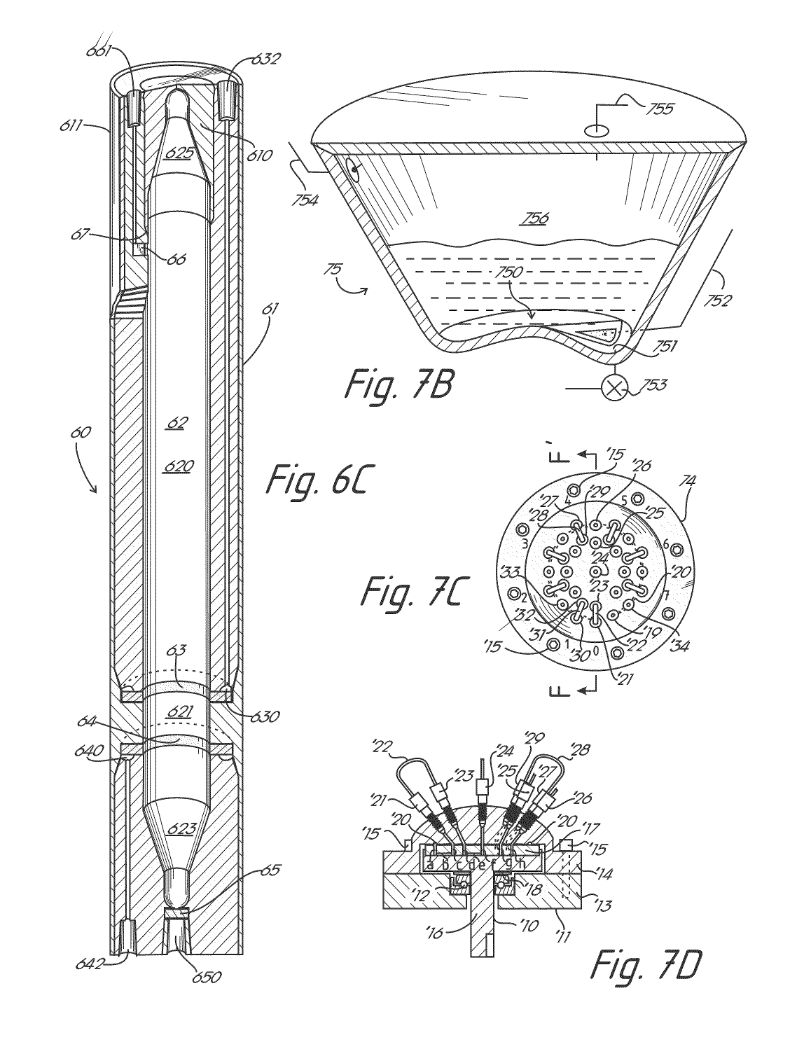

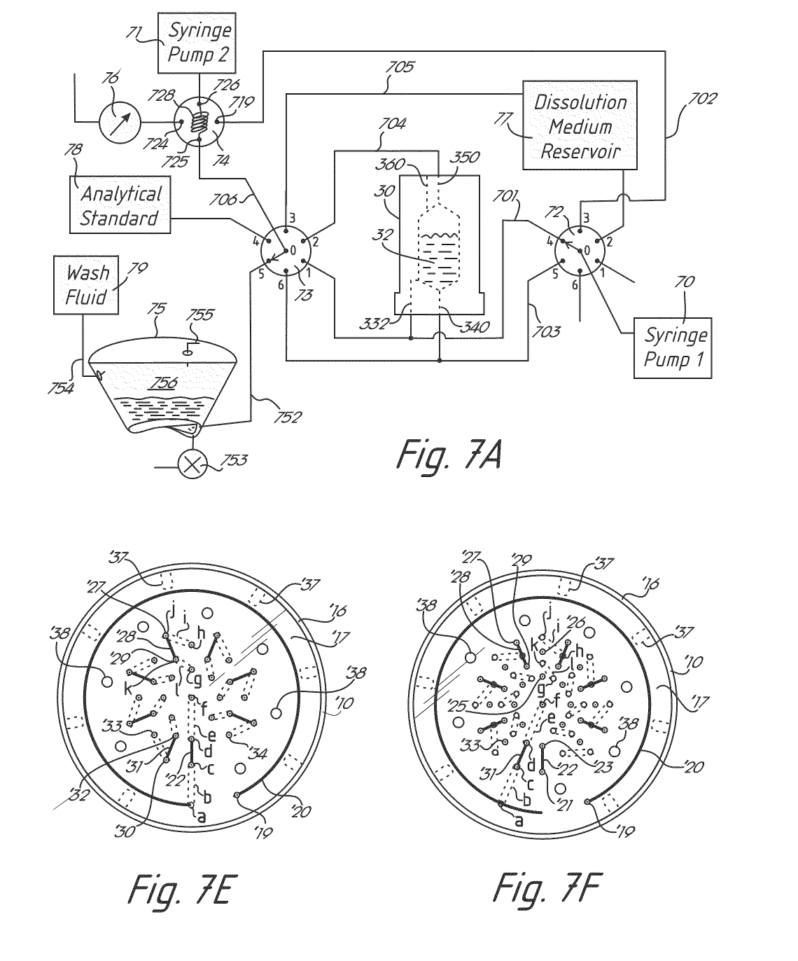

Referring now to FIG. 7A, the schematic diagram thereof shows fluidics and combination of functional components of the first dissolution testing apparatus in use with the first dissolution testing cell 30 in an automated determination of differential rate of dissolution of an ingredient of a solid dosage product as a function of, at least, cumulative mass of the ingredient dissolved therefrom, under one or more hydrodynamic dissolution conditions. The functional components of the first dissolution testing apparatus comprise: syringe pump “1” 70; syringe pump “2” 71; first multi-port selection valve 72; second multi-port selection valve 73; sampling valve 74; cumulative vessel 75; and fluid conduits illustrated by solid line connections, some of which are referenced as shown (701, 702, 703, 704, 705, and 706, hereinafter sometimes, interchangeably, fluid connection lines or simply fluid lines). Referenced at 76 is a detector for flow injection analysis (FIA), 77 a dissolution medium reservoir, 78 analytical standard for calibration of detector 76 (or calibration check thereof), and 79 a source of wash fluid for use in cleaning cumulative vessel 75 in between dissolution tests. Dissolution testing cell 30, including its various fluid connection ports, is as described in detail herein before and illustrated in FIGS. 3A to 3E. A more detailed view of cumulative vessel 75 is shown in FIG. 7B, and sampling valve 74 in FIGS. 7C to 7F. Relation of one of the functional components to another is as depicted in FIG. 7A and will be further understood from the following description of use of the apparatus.

Use of the apparatus in the modified first mode of using dissolution testing cell 30 is described below as an example in detail. A sample of the solid dosage product is placed in cell cavity 32 (FIG. 7A, more details in FIG. 3C) of dissolution testing cell 30. Upon closing, the dissolution testing cell 30 is connected to fluid conduits of the dissolution testing apparatus by way of the cell's fluid connection ports, as schematically illustrated in FIG. 7A. First multi-port selection valve 72 is switched to port “2” (i.e., connecting port “0” to port “2”, FIG. 7A) and syringe pump “1” 70 withdraws a volume of dissolution medium from dissolution medium reservoir 77. First multi-port selection valve 72 is then switched to port “5” and syringe pump “1” 70 discharges, to fluid connection port 340 of dissolution testing cell 30, a first known volume of dissolution medium equal to about volume of the conical end 320 of cell cavity 32 (FIG. 3C), as a stream at a first controlled flow rate. Immediately afterwards, first multi-port selection valve 72 is switched to port “4” (as is presently shown in FIG. 7A) and syringe pump “1” 70 discharges, to fluid connection port 332 of dissolution testing cell 30, a second known volume of dissolution medium, as a stream at a second controlled flow rate programmed or set to provide a continued upward dissolution medium flow in cell cavity 32, while at the same time causing a rotational component of movement of the dissolution medium therein. While first multi-port selection valve 72 selects ports “5” and “4”, and syringe pump “1” 70 discharging, second multi-port selection valve 73 selects port “5” (as is presently shown in FIG. 7A), sampling valve 74 in a sampling position (in which sample loop, 728, is placed in between ports 725 and 726, FIG. 7A, and connects therebetween, as is presently shown), and syringe pump “2” 71 withdraws a volume of contents of cumulative vessel 75, which, as will be described below, accumulates dissolution medium exiting from cell cavity 32 of dissolution testing cell 30 during a dissolution test. A period of no inward dissolution medium flow into cell cavity 32 (i.e., a period of discrete settlement) allows fluidized particulates of the sample to settle to bottom of cavity 32. During this period (of discrete settlement), first multi-port selection valve 72 is switched to port “3”, sampling valve 74 to an analyzing position (in which sample loop, 728, is placed in between ports 724 and 719, FIG. 7A, and connects therebetween), and syringe pump “1” 70 discharges a steady stream of dissolution medium as part of (see further description below) a carrier solvent for flow injection analysis (FIA), to port 719 via fluid conduit 702, sending contents of sample loop 728 to detector 76. At the end of the period of discrete settlement, second multi-port selection valve 73 is switched to port “1”, sampling valve 74 back to the sampling position, and syringe pump “2” 71 withdraws dissolution medium from cell cavity 32 via fluid connection port 332 and tangential openings 33 (FIG. 3C), allowing the dissolution medium withdrawn to be sampled by sample loop 728. Sampling valve 74 is then switched again to the analyzing position and, while first multi-port selection valve 72 maintains selection of port “3”, syringe pump “1” 70 discharges again a steady stream of dissolution medium as FIA carrier solvent to port 719 via fluid conduit 702, sending contents of sample loop 728 to detector 76. Next, second multi-port selection valve 73 is switched to port “6”, sampling valve 74 back to the sampling position, and syringe pump “2” 71 completely withdraws dissolution medium out of cell cavity 32 via bottom opening 34 and fluid connection port 340 (FIG. 3C). Next, second multi-port selection valve 73 is switched to port “5”, and syringe pump “2” 71 discharges its entire contents to cumulative vessel 75. While syringe pump “2” 71 discharges its entire contents, the steps described above begin to repeat, to a completion of dissolution of the ingredient of the sample. An exception to repeated cycles of the steps described above is the first and the second cycles thereof, at the beginning of a dissolution test. In the first cycle thereof, a step of withdrawing from analytical standard reservoir 78 via port “4” of the second multi-port selection valve 73 replaces the step of withdrawing from an (empty) cumulative vessel 75 via port “5”. In the second cycle thereof, a step of withdrawing from dissolution medium reservoir 77 via port “3” of the second multi-port selection valve 73 by way of fluid conduit 705, replaces the step of withdrawing from the cumulative vessel 75, which, at the end of the first cycle, contains dissolved ingredient the concentration of which is known from the first cycle. The step of withdrawing from dissolution medium reservoir 77 provides a blank FIA data point, for checking, e.g., any carry over error of the FIA.

It will be seen from the schematic diagram shown in FIG. 7A that the presently shown preferred embodiment of apparatus of the invention also allows syringe pump “2” 71 to withdraw content of cell cavity 32 of dissolution testing cell 30 from port 350 of the dissolution testing cell, via fluid conduit 704, by way of port “2” of second multi-port selection valve 73, the dissolution testing cell 30 comprising a sampling probe 355 shown in FIG. 3E and described herein before. Fluid connection port 360 may be left open to atmosphere, closed, or connected to a valve-controlled source of inert gas (such as nitrogen). The latter may be pressurized and, under valve control, used to pressurize cell cavity 32 during withdrawing of contents thereof by syringe pump “2” 71, to facilitate (as a secondary, pneumatic pump) the withdrawing, in a dissolution test.

A programmable microprocessor controller (not shown in the drawings) controls motors that drive the syringe pumps (e.g., 70), the multi-port selection valves (e.g., 73), the sampling valve (74), and various ancillary valves such as 753. Various flow schemes may be programmed into a dissolution test by way of the programmable microprocessor controller, including various values of the first and the second known volume described above, their controlled flow rates including any gradient of the second controlled flow rate, and various sequences or orders of flow events. See description on modes of using dissolution testing cell 30 given hereinbefore.

Ports “1” and “6” of first multi-port selection valve 72 in the presently shown (FIG. 7A) preferred embodiment of apparatus of the invention are currently spare ports not in use. For a multi-media (two or more media) dissolution test involving, e.g., an acid stage and a neutral stage, in testing, e.g., an enteric coated pharmaceutical tablet, the spare ports can be connected to a second and a third dissolution medium reservoir, respectively, and programmed for automatic change of dissolution medium during the dissolution test.

Cumulative vessel 75 may be of any design suitable for the purpose of use thereof described above. In the presently shown and illustrated preferred embodiment of apparatus of the invention, cumulative vessel 75 is of an inventive design described and shown in more detail below and in FIG. 7B.

Referring to FIG. 7B, cumulative vessel 75 comprises vessel cavity 756 having an axially symmetric shape (in the present preferred embodiment, reversed cone-shape) except bottom 750. Bottom 750 is a surface which spirals down to a lowest point 751 in one full turn of three-hundred-sixty (360) degrees. To the lowest point 751 are fitted an inlet for incoming dissolution medium (coming from, e.g., dissolution testing cell 30) during a dissolution test, and an outlet for complete drainage of accumulated dissolution medium and any washing fluid used to clean the cavity 756, at the end of a dissolution test. Fluid line 752 directs incoming dissolution medium entering vessel cavity 756 in a direction tangential to circular side wall thereof, at the lowest point 751, causing dissolution medium in cavity 756 to swirl for mixing with the incoming dissolution medium, and allowing syringe pump “2” 71 to sample even a small volume of dissolution medium accumulated in vessel cavity 756 at an early stage of a dissolution test. Vessel cavity 756 may be a gas-tight space connected to a valve-controlled source of pressurized inert gas such as nitrogen through fluid connection line 755, pressure from the pressurized inert gas facilitating sampling of dissolution medium in vessel cavity 756 by syringe pump “2” 71. Fluid line 754 directs wash fluid entering vessel cavity 756 in a direction tangential to circular side wall thereof, at a high point thereon, allowing the wash fluid to wash the side wall in a circular and downward motion, at an end of a dissolution test.

Sampling valve 74 for a single set up of fluidics shown in FIG. 7A and described above may be a traditional 6-port HPLC injection valve, known for its use as a (single stream) sampling valve in FIA of a (single) stream of fluid (i.e., an injected sample). In the presently shown and illustrated preferred embodiment of apparatus of the invention, however, a plurality of seven replicates of the set up, for testing a plurality of up to seven samples at a time, is included in the apparatus. The schematic in FIG. 7A illustrates fluidics of one of the seven replicates. A syringe pump illustrated in FIG. 7A and described above, e.g., syringe pump “1” 70, is part of a syringe pump group comprising a plurality of seven replicate sets of syringe barrels and plungers, the plungers being ganged and driven by a common stepping motor controlled by the programmable microprocessor controller. Similarly, a multi-port selection valve, e.g., first multi-port selection valve 72, is part of a multi-port selection valve group comprising a plurality of seven replicate multi-port selection valves ganged and driven by a common stepping motor controlled by the programmable microprocessor controller. The construction of such a syringe pump group and multi-port selection valve group by mere ganging together of known structures is without of invention and not described further herein.

To achieve simultaneous and parallel sampling of up to seven streams of liquid sample for FIA using a single detector, an inventive multi-stream sampling valve 74 is used in the presently shown and illustrated preferred embodiment of apparatus of the invention. An embodiment of the inventive multi-stream sampling valve 74 is illustrated in detail in FIGS. 7C to 7F. In FIGS. 7C to 7F, for reason of a small space available to annotation of reference numerals, certain reference numerals start with a space-saving apostrophe, which is to be understood as an abbreviation for Roman numeral “7”, following a self-apparent numbering style used for reference numerals in the drawings herein, in which the first (left most) digit of a reference numeral generally repeats after the numeral of the figure in which a part referenced by the reference numeral first appears in the drawings (if a figure has a two digit number, the first two digits of the reference numeral). For example, '26 is to be understood as abbreviation for 726, referencing a part first appearing in FIG. 7C.

Referring to the front sectional view in FIG. 7D, the multi-stream sampling valve comprises rotor '10 (i.e., 710), stator '11, ball bearing assembly '12, and spacer sleeve '18, in an assemblage relationship as shown. Stator '11 comprises a top plate '14 and a bottom plate '13, fastened together by a plurality of fasteners two of which are visible in the view in FIG. 7D and referenced at '15. Rotor '10 comprises support '16 (with a driving shaft) and rotor plate '17. A plurality of through-holes are formed in rotor plate '17, several of which are visible in FIG. 7D and referenced at a, c, d, f, g, and h (letters used instead of roman numerals for space reasons). A short groove, referenced at b, formed into bottom surface of rotor plate '17, connects through-holes a and c. Similarly, groove e connects through-holes d and f. Through-holes of the rotor plate '17 are shown as small open circles (e.g., a) in the top plan views of the rotor ('10) in FIGS. 7E and 7F, and grooves formed into bottom surface of rotor plate '17 as hidden structures in broken line illustrations (e.g., b). Groove i, formed into bottom surface of rotor plate '17 and shown as a hidden structure in broken line illustration behind through-hole h in FIG. 7D (but not referenced therein for lack of annotation space) and in FIGS. 7E and 7F (referenced at i), connects through-holes h and j, the latter being shown as a hidden structure (behind through-hole h) in broken line illustration in FIG. 7D (but not referenced therein), and in FIGS. 7E and 7F (referenced at j). Groove l (lower case bold letter “l”), formed into bottom surface of rotor plate '17 and shown as a hidden structure (behind through-hole g) in broken line illustration in FIG. 7D (but not referenced therein), and in FIGS. 7E and 7F (referenced at l), connects through-holes g and k, the latter being shown as a hidden structure (behind through-hole g) in broken line illustration in FIG. 7D (but not referenced therein), and in FIGS. 7E and 7F (referenced at k). In FIG. 7E, all of the above described through-holes (small open circles) are covered by small circles with a dot inside and hence not visible, except the through-hole a. The small circles with a dot inside represent positions of overlaying bottom orifices of through-holes of top plate '14, when the bottom orifices are in vertical alignment with said all through-holes of rotor plate '17 but a, as presently seen in the drawing in FIG. 7E, which shows the small circles with a dot inside superimposed onto the top plan view of rotor '10. Onto the top plan view of rotor '10 in FIG. 7E is also superimposed a heavy solid line illustration '20 which indicates position of a groove formed into bottom surface of top plate '14 along a circular path on the bottom surface. Groove '20 (fluid distribution channel), as referenced, is visible in FIG. 7D, in a cross sectional view thereof, and shown in FIG. 7C as a hidden structure in broken line illustration ('20). Also superimposed on top of the top plan view of rotor '10 in FIG. 7E are heavy solid line illustrations (e.g., '22, '28) indicating position of (sample and bypass) loops which are described in more detail below.

The through-holes of top plate '14 each comprise an outer depth threaded and shaped to receive a threaded fluid conduit connection nut (e.g., '21). In FIG. 7D, five threaded fluid conduit connection nuts located in the cross-section plane are drawn in front elevational views and referenced at '21, '23, '24, '25, and '26, respectively. Two additional nuts '27 and '29, located behind '26 and '25, respectively, are drawn, as is a sample loop '28 connecting between the through-holes (hidden structures in broken line illustrations) that receive nuts '27 and '29. A short fluid conduit '22, referred to as a “bypass loop”, connects between the through-holes that receive nuts '21 and '23. Other nuts and sample loops which are present, and some of which would be visible in the front sectional view in FIG. 7D, are not drawn therein for sake of clarity, but are drawn in the top plan view in FIG. 7C. The top plan view shows a distribution (spread) of the fluid conduit connection nuts (selectively referenced at '26, '27 and '33), the sample loops (selectively referenced at '28 and '31), and the bypass loop ('22). With an exception of the through-holes that receive nuts '24 and '19, all through-holes of top plate '14, and the nuts they receive, are slanted towards a center when seen in a vertical cross-sectional view (e.g., FIG. 7D), so that access space is available for threading in the nuts from outside of the valve, and size of the rotor plate '17 can be made small in reference to size of spread of the nuts. The through-hole for nut '24 is vertically oriented as shown in FIG. 7D, and for '19 slanted towards direction of extension (FIG. 7C) of groove '20.

The positions of nuts '21 and '23 as a collection, the bypass loop '22 connected thereby, and the through-holes of top plate '14 associated therewith as described above, are marked by a Roman numeral “0” on the top surface of top plate '14 (FIG. 7C). The positions of nuts '27 and '29 as a collection, the sample loop '28 connected thereby, and associated through-holes of top plate '14 described above, are marked by a Roman numeral “4” on the top surface of top plate '14. Six other sets of sample loops, nuts, and through-holes, at six other different positions, are marked (FIG. 7C) by a Roman numeral selected from the integer series of “1” to “7” excepting “4” for position “4” already described. The sample loop ('31, FIG. 7C) at position “1”, and associated nuts and through-holes ('30 and '32), are disposed in a twenty-two-and-a-half (22.5) degree rotational relationship to the bypass loop ('22) and associated nuts and through-holes ('21 and '23) at position “0”. Each sample loop and associated nuts and through-holes at a subsequent position is disposed in a forty-five (45) degree rotational relationship to those at a previous position. In FIGS. 7E and 7F, position of the sample loops (e.g., '28) and the bypass loop ('22) is indicated by way of heavy solid line illustrations superimposed onto the top plan view of rotor '10. Each of the through-holes of the top plate '14 that is not connected to one end of a (sample or bypass) loop is called sometimes herein a (fluid connection) port of the valve 74.

A plurality of larger through-holes of rotor plate '17, shown as larger open circles two of which are indicated at '38 in FIGS. 7E and 7F, and a plurality of rectangular cuts into bottom surface of '17, shown as hidden structures in broken line illustrations two of which are indicated at '37 in FIGS. 7E and 7F, provide receptacles which receive matching protruding structures formed on top surface of support '16, for rotor plate '17 to engage with support '16 to form one unit of rotor '10.

It is noted that the drawings in FIGS. 7E and 7F are at a larger scale than the drawings in FIGS. 7C and 7D, in order to show details of structures of rotor plate '17.

Rotor '10 rotates among also eight (8) positions, “0 (zero)” to “7 (seven)”, each corresponding to a different loop position on the top plate '14 of the stator '11. Of the eight (8) positions, position “0” is a sampling position. In the sampling position, each of up to seven streams of fluid flows through a different flow path between a respective pair of ports of the valve 74, passing through (and hence sampled by) a respective sample loop disposed therein, and an FIA carrier solvent stream, entering valve 74 at '19 (FIG. 7C) and leaving at '24, bypasses all sample loops. The other positions are seven analyzing positions each of which allows contents of a sample loop for one of the up to seven streams to be placed into the FIA carrier solvent stream, one at a time, to be sent to a single FIA detector (i.e., detector 76, FIG. 7A). The seven analyzing positions are described by way of example in more detail below, after a description in more detail of the sampling position “0”. In the description below, including its reference to drawings in FIGS. 7A to 7F, the one replicate of set up of fluidics depicted in FIG. 7A provides a stream (a fourth stream) to be sampled and analyzed at position “4” of the multi-stream sampling valve 74. Thus, port 725 of sampling valve 74 drawn in FIG. 7A corresponds to (i.e., is the port that receives) fluid conduit connection nut '25 in FIGS. 7C and 7D. Similarly, 726 in FIG. 7A corresponds to '26 in FIGS. 7C and 7D, and 728 in FIG. 7A is '28 in FIGS. 7C and 7D. Fluid conduit 706 schematically illustrated in FIG. 7A is a fluid conduit partially drawn (but not referenced) in FIGS. 7C and 7D, that connects by '25 to valve 74. Fluid conduit 702 schematically illustrated in FIG. 7A is a fluid conduit that connects at one end to multi-stream sampling valve 74 by nut '19, drawn in FIG. 7C, and at the other end, to a combination (not drawn) of streams coming from port “3” of first multi-port selection valve (72) of each of the seven replicates of set up of fluidics depicted in FIG. 7A. Thus, when first multi-port selection valve (72) of each of the seven replicates of set up of fluidics (FIG. 7A) selects port “3”, a discharge from syringe pump “1” (70) of each of the seven replicates of set up of fluidics is combined with discharges from the others to provide an FIA carrier solvent to sampling valve 74. Port 724 of sampling valve 74 drawn in FIG. 7A is the port that receives nut '24 drawn in FIGS. 7C and 7D, connecting detector 76 (FIG. 7A) to the valve 74.

Referring to FIGS. 7D and 7E, presently shown rotor '10 is in position “0”. In position “0”, through-holes c, d, and f (FIG. 7D) of rotor plate '17 align with orifice of through-holes on bottom surface of top plate '14 for nuts '21, '23, and '24, respectively, and through-holes g and h align with orifice for '25 and '26, respectively. In the position “0”, rotor '10 allows an incoming FIA carrier solvent stream from 702 (FIG. 7A), in fluid communication with groove '20 via nut '19 (FIGS. 7C and 7E), to, after traveling an entire length of groove '20 (FIG. 7E), pass through (FIG. 7D) hole a, groove b, hole c, loop '22 (via nuts '21 and '23), hole d, groove e, and hole f, exiting via nut '24 for detector 76 (FIG. 7A). The FIA carrier solvent stream thus bypasses each and every sample loop (e.g., '28). The latter, as can be seen by way of example at position “4” ('28, FIGS. 7C, 7D, and 7E), is presently placed in a sample stream (i.e., the fourth sample stream that passes through sample loop '28 via nut '25, hole g, groove 1, and hole k at one end, FIGS. 7D and 7E, and hole j, groove i, hole h, and nut '26 at the other).

Referring to FIG. 7F, rotor '10 has rotated twenty-two-and-a-half (22.5) degrees from position “0”, to the presently illustrated position “1”, in which through-holes c and d now align with bottom orifices of the through-holes of top plate '14 that connect to sample loop '31 (FIGS. 7F and 7C) at position “1”, completing a flow path wherein FIA carrier solvent from fluid conduit 702 enters groove '20 via nut '19, travels a distance along '20 to hole a, passes through groove b, hole c, loop '31, hole d, groove e, and hole f, for detector 76 via nut '24. Each of six subsequent successive rotations of forty-five (45) degrees each, of the rotor '10, completes another flow path in which a sample loop at another position becomes a part, one at a time, until the rotor '10 reaches position “7”. Rotating sixty-seven-and-a-half (67.5) degrees from position “7” returns the rotor '10 to position “0”.

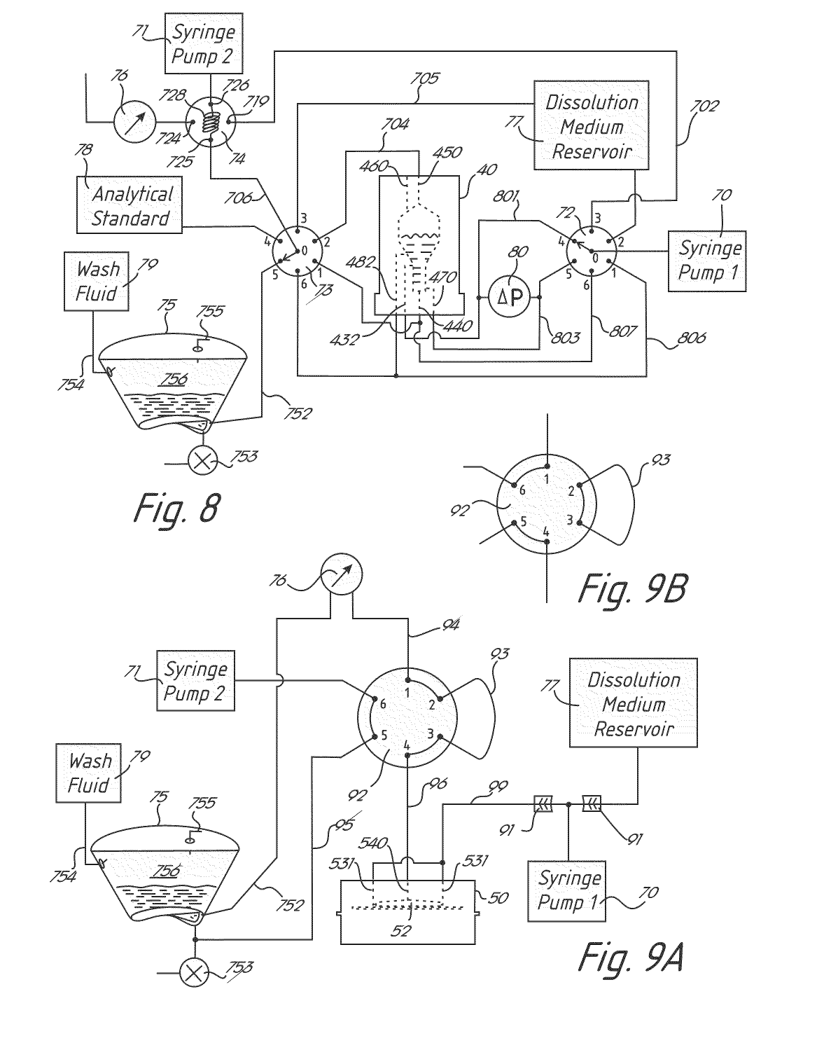

Referring to FIG. 8, the schematic diagram thereof shows one replicate of fluidics and combination of functional components of the second dissolution testing apparatus constructed in accordance with a preferred embodiment of apparatus of the invention, in use with the second dissolution testing cell 40 of FIGS. 4A to 4C for determination of properties of dissolution including hydraulic conductivity and hydraulic resistance in accordance with a preferred embodiment of method of the invention. The second dissolution testing apparatus shown in FIG. 8 may be best viewed as a modification from the first dissolution testing apparatus in FIG. 7A. A principal difference of the fluidics and combination of functional components shown in FIG. 8, from that shown in FIG. 7A, is presence of a differential pressure transducer 80 and manner in which the differential pressure transducer 80 is disposed in relation to fluid connection ports of the dissolution testing cell 40, by way of an advantageous arrangement of fluid conduits including 801, 803, 806 and 807, as shown (FIG. 8). Specifically, each side of a diaphragm of the differential pressure transducer 80 connects to one of a pair of side openings 43 and 47 (FIG. 4A) via fluid connection ports 430 and 470 (FIG. 8) of dissolution testing cell 40.

In each of the apparatus illustrated in FIGS. 7A and 8 and described above, syringe pump “2” 71, sampling valve 74, and second multi-port selection valve 73, in combination, constitute means for selectively sampling dissolution medium from cell cavity (e.g. 32) of a dissolution testing cell and vessel cavity 756 of cumulative vessel 75 for on-line determination of mass of an ingredient differentially and cumulatively dissolved in the dissolution medium, respectively.

Where a dissolution test requires off-line determination involving, e.g., off-line chromatographic (e.g., HPLC) separation, a fraction collector (i.e., its fraction collection vials) may replace cumulative vessel 75 and the online detector 76 of the shown and described preferred embodiments of apparatus of the invention. In such a case, differential rates of dissolution may be determined experimentally from fractions collected and cumulative masses dissolved integrated from the differential rates of dissolution. Automated dilution of each fraction collected, to an appropriate concentration suitable for direct off-line analysis (e.g., direct HPLC injection), where dilution may be necessary, may be achieved by way of syringe pump “2” 71 and fresh dissolution medium (diluent) from fluid conduit 705.

Where a dissolved ingredient can be quantified by way of fiber optic spectrophotometric determination, a plurality of fiber optic detectors, one for each replicate of the set up of fluidics depicted in FIGS. 7A and 8, may replace the multi-stream sampling valve 74 and the single detector 76 of the shown and described preferred embodiments of apparatus of the invention.

Referring now to FIG. 9A, the schematic diagram thereof shows fluidics and combination of functional components of the third dissolution testing apparatus in use with the third dissolution testing cell 50 (FIG. 5B) for determining rate of dissolution of a solid ingredient of a transdermal patch or cream as a function of, at least, cumulative mass of the ingredient dissolved therefrom. The third dissolution testing apparatus comprises: syringe pump “1” 70; syringe pump “2” 71; check valves 91; cumulative vessel 75; six-port switching valve 92; and fluid conduits illustrated by solid line connections, some of which are referenced (e.g., 99, 93, 94, 95, and 96).

Syringe pump “1” 70 withdraws dissolution medium from dissolution medium reservoir 77, and discharges to ports 531 of dissolution testing cell 50 via fluid conduit 99. Check valves 91 ensure uni-direction of flow of the dissolution medium in fluid conduit 99. Fluid conduit 96 connects port 540 of dissolution testing cell 50 to port “4” of six-port switching valve 92. Fluid conduit 93 is a short loop connecting ports “2” and “3” of valve 92. Fluid conduit 94 connects port “1” thereof to detector 76. Detector 76 in the present embodiment is a non-destructive detector (e.g., a UV-visible detector) comprising a flow-through cell. Exit side of the flow-through cell of the detector 76 is connected by fluid conduit 752 to cumulative vessel 75. Fluid conduit 95 connects a lowest point of the cavity of cumulative vessel 75 to port “5” of valve 92. Syringe pump “2” is connected to port “6” of the valve.

During an in vitro dissolution test, valve 92 switches between two positions, a first position as shown in FIG. 9A and a second position in FIG. 9B. Referring to FIG. 9A, the valve being in the presently shown first position, a discharge from syringe pump “1” 70 enters cell cavity 52 of dissolution testing cell 50 via ports 531, exiting therefrom via port 540, entering valve 92 via port “4”, passing through loop 93, leaving valve 92 at port “1”, reaching detector 76 via fluid conduit 94, and, after detection by detector 76, entering vessel cavity 756 of cumulative vessel 75. The detection (of mass of an ingredient dissolved in dissolution medium exiting from dissolution testing cell 50 per unit time) allows determination of differential rate of dissolution of the ingredient dissolving from a transdermal patch or cream sample placed in the dissolution testing cell 50.

Upon determining a value of differential rate of dissolution as described above, syringe pump “2” 71 withdraws a sample of contents of vessel cavity 756 via fluid conduit 95, by way of ports “5” and “6” of valve 92. Upon valve 92 switching subsequently to the second position (FIG. 9B) in a next step, syringe pump “2” 71 discharges the sample of contents withdrawn from vessel cavity 756 to detector 76 via ports “6” and “1” of valve 92, for determining cumulative mass of the ingredient dissolved therein. At the same time, syringe pump “1” 70 refills from dissolution medium reservoir 77.

Where the detection of a dissolved ingredient requires a destructive detector 76 (e.g., a mass spectrometer), or simply an FIA technique is desired for the detection, a skilled artisan taught by the present disclosure will be able to replace the flow-through detector 76 (FIG. 9A) with an FIA sampling valve, and provide an FIA carrier solvent to the sampling valve to send contents of a sample loop thereof to detector 76, in a manner similar to that shown and described for, e.g., the first dissolution testing apparatus (FIG. 7A) herein above.

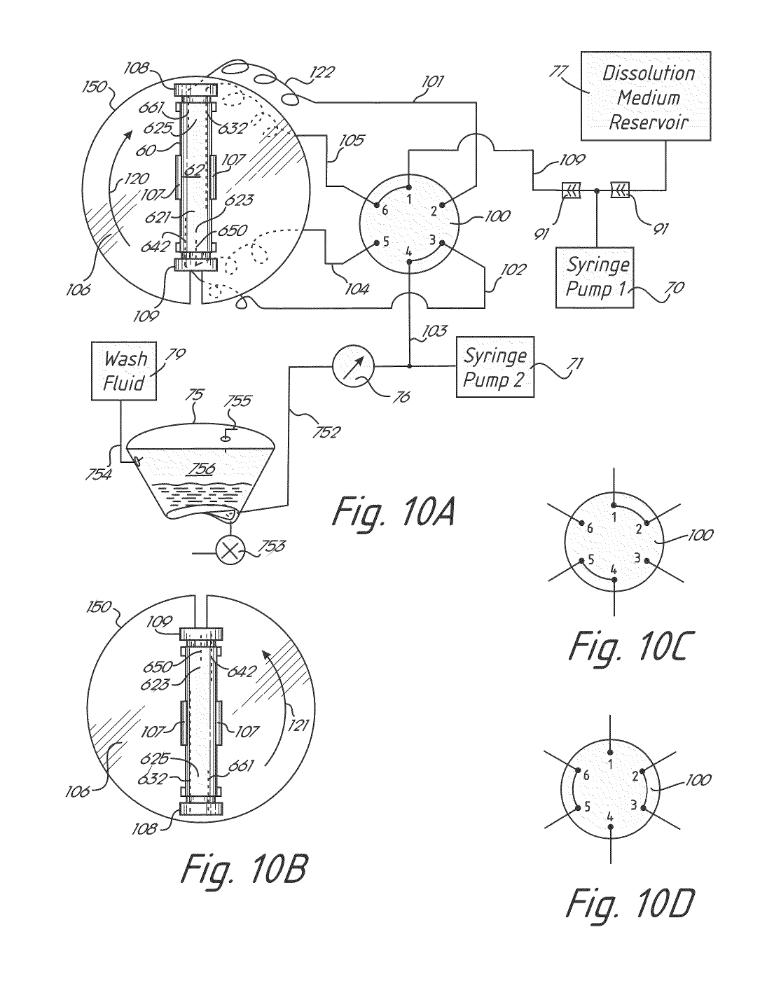

Turning now to FIG. 10A, the schematic diagram thereof shows fluidics and a combination of functional components of the fourth dissolution testing apparatus in use with the fourth dissolution testing cell 60 (FIG. 6C) for determining vertical velocity of fluidization of a dissolving particulate of a solid dosage product and for determining other properties of dissolution of a dissolving ingredient thereof, each as a function of, at least, cumulative mass of the ingredient dissolved therefrom. The fourth dissolution testing apparatus (FIG. 10A) comprises: syringe pump “1” 70; syringe pump “2” 71; check valves 91; cumulative vessel 75; six-port switching valve 100; rocker assembly 150; and fluid conduits illustrated by solid line connections several of which are referenced at 109, 101, 102, 103, 104, and 105. Rocker assembly 150 comprises, in the present embodiment: a vertically disposed turntable 106; means 107 for holding a fourth dissolution testing cell 60 in position on the vertically disposed turntable; first end connection means 108; and, second end connection means 109. First end connection means 108 connects one end of fluid conduit 101 to port 661 of dissolution testing cell 60, and one end of fluid conduit 105 to port 632 thereof. Second end connection means 109 connects one end of fluid conduit 102 to port 642 of dissolution testing cell 60, and one end of fluid conduit 104 to port 650 thereof. The other end of fluid conduit 101, fluid conduit 105, fluid conduit 102, and fluid conduit 104, connects to port “2”, port “6”, port “3”, and port “5”, respectively, of six-port switching valve 100, as shown. Fluid conduits 101, 105, 102, and 104 each comprise a flexible length (drawn in spirals, e.g., 122) near turntable 106, so that turntable 106 can freely rock between its two positions.

Syringe pump “1” 70 withdraws dissolution medium from dissolution medium reservoir 77, and discharges to port “1” of six-port switching valve 100 via fluid conduit 109. Check valves 91 ensure flow of dissolution medium in the direction indicated by arrows of the drawing symbols 91. Fluid conduit 103 connects port “4” of six-port switching valve 100 to one side of flow-through cell of non-destructive detector 76, while syringe pump “2” 71 tees in therebetween. The other side of flow-through cell of 76 connects to cumulative vessel 75 via conduit 752.

In an in vitro dissolution test, valve 100 switches among three positions, a first position as shown in FIG. 10A, a second position FIG. 10C, and a third position FIG. 10D. Turntable 106 rotates clockwise 120 and counter-clockwise 121 between two positions, a first position as shown in FIG. 10A, and a second position FIG. 10B.

Referring to FIG. 10A, valve 100 being in the presently shown first position, ports 650 and 661 of dissolution testing cell 60 are closed off by valve 100. A discharge from syringe pump “1” 70, at a controlled flow rate, creates a flow, at the controlled flow rate, entering cell cavity 62 of dissolution testing cell 60 via port 632, after passing through ports “1” and “6” of valve 100. The flow exits cell cavity 62 via port 642, entering valve 100 again via port “3”, by way of conduit 102, leaving 100 via port “4”, and passing through flow cell of detector 76 before being accumulated in cumulative vessel 75. Upon turntable 106 rapidly rotating (i.e., rocking) counter-clockwise to the presently shown first position (FIG. 10A), from its second position (FIG. 10B) in which a particulate or particulates of a sample under testing had settled to first end 625 of cell cavity 62, the particulate or particulates start to re-settle from first end 625 to second end 623. An ingredient dissolved in the flow in analytical section 621, upon a particulate containing the ingredient passing through the analytical section after settlement from first end 625, is detected by detector 76. Time taken for the particulate to reach the analytical section is used to compute vertical velocity of fluidization of the particulate after calibration against a standard of a known vertical velocity of fluidization.

In FIG. 10C, valve 100 being in the second position, ports 632 and 642 of dissolution testing cell 60 are closed off by valve 100. With turntable 106 in its second position (FIG. 10B), and a particulate or particulates of a sample having settled to first end 625 of cell cavity 62, fresh dissolution medium is delivered by syringe pump “1” 70, enters cell cavity 62 via port 661 of cell 60 by way of ports “1” and “2” of valve 100, and exits cell cavity 62 via port 650, filling 62 with a column of fresh dissolution medium for a next cycle of particulate re-settling and determining of vertical velocity of fluidization. Determining mass of an ingredient dissolved in dissolution medium exited from 62 allows computation of differential rate of dissolution of the ingredient (as mass dissolved per cycle) under a discrete settlement hydrodynamic dissolution condition (similar to mode five of using first dissolution testing cell 30). Dividing the mass by twice distance between 625 and 623 yields mass dissolved per unit linear vertical distance of settlement (each cycle of the determining consists of two cycles of discrete settlement, i.e., from 625 to 623 and back).

In FIG. 10D, valve 100 being in its third position, fluid conduit 103 being closed off at port “4” of valve 100, syringe pump “2” 71 withdraws a sample of content of cumulative vessel 75. The sample of content withdrawn passes through non-destructive detector 76, allowing determination of cumulative mass of an ingredient dissolved therein (from determined concentration and known volume of fluid in 756).

While the disclosure herein includes description and illustration of certain specific embodiments of the invention, it is understood that the embodiments described and illustrated are not intended to be exhaustive. Accordingly, the invention is not limited to such embodiments, but in scope, as defined by claims appended hereto, embraces any and all equivalents of the embodiments, modifications thereto, combinations and re-combinations of inventive features thereof, and embodiments comprising a minimum of limiting elements of one or more of the appended claims, all as apparent to those having ordinary skills in the art, taught by the present disclosure.

For example, a modification to the FIG. 6C embodiment of dissolution testing cell 60 may include a narrowed analytical section 621.

For another example, a modification to the FIG. 6C embodiment may include, in combination, the FIG. 4A pressure-sensitive packed bed dissolution testing feature.

The term “an algebraic transform (of a property of dissolution)”, as used herein, denotes a mathematical transform (of the property of dissolution) in which a subject of transform (the property of dissolution) is an only variable and in which every mathematical operation is algebraic. Examples of an algebraic transform include: specific hydraulic resistance as an algebraic transform of specific hydraulic conductivity, in equation (eq. 32); and mass dissolved per unit distance of local dissolution medium flow as an algebraic transform of differential rate of dissolution (i.e., the division of the latter by a linear distance of the local dissolution medium flow per unit time).

What is claimed is:

1. A method of manufacturing a solid dosage product to achieve desired or controlled rate of dissolution of an ingredient thereof in an in vivo dissolution environment, the in vivo dissolution environment comprising an in vivo dissolution medium and a complex in vivo hydrodynamic dissolution condition, the method comprising:
(a.) determining and evaluating at least one property selected from a group consisting of:
as a function of, at least, cumulative mass of the ingredient dissolved from a sample of the solid dosage product,
(a1.) differential rate of dissolution of the ingredient dissolving from the sample under a given dissolution condition;
(a2.) hydraulic conductivity of a particulate or bed of particulates of the sample in a dissolution medium representing or substantially simulating the in vivo dissolution medium;
(a3.) vertical velocity of fluidization of a particulate or particulates of the sample in the dissolution medium; and
(a4.) a property equivalent to an algebraic transform of a property selected from a group consisting of property (a1.), property (a2.), and property (a3.);
for the ingredient dissolving in a given dissolution process or under a given dissolution condition,
(a5.) AUrMC, as defined by equation (eq. 6); and
(a6.) a property equivalent to an algebraic transform of property (a5.); and
under a cyclic dissolution condition of an in vitro dissolution process each cycle thereof consisting of a time-series of dissolution conditions each thereof simulating a component dissolution condition of an in vivo dissolution process for a relative duration to length of cycle reflecting probability of occurrence of the component dissolution condition at a point of time in the in vivo dissolution process equal to a point of time of the cycle in the in vitro dissolution process,
(a7.) differential rate of dissolution of the ingredient as a function of the point of time of the cycle;
(a8.) cumulative mass of the ingredient dissolved as a function of the point of time; and
(a9.) a property equivalent to an algebraic transform of a property selected from a group consisting of property (a7.) and property (a8.); and
(b.) making a manufacturing decision based on result of the determining and the evaluating.

2. The method of claim 1, wherein the at least one property comprises a member selected from a subgroup consisting of property (a1.) differential rate of dissolution and the property of (a4.) equivalent to an algebraic transform of property (a1.), as a function of either the cumulative mass of the ingredient dissolved or at least both the cumulative mass and an independently variable dissolution medium contact time.

3. The method of claim 1, wherein the at least one property comprises a member selected from a subgroup consisting of property (a1.) differential rate of dissolution and the property of (a4.) equivalent to an algebraic transform of property (a1.), the property equivalent being a member selected from a group consisting of: (A.) mass of the ingredient dissolved per unit linear vertical distance of local dissolution medium flow of a discrete fluidization and settlement hydrodynamic dissolution condition; (B.) mass of the ingredient dissolved per unit linear vertical distance of settlement of a discrete settlement hydrodynamic dissolution condition; (C.) mass of the ingredient dissolved per unit linear distance of local dissolution medium flow of a fixed position hydrodynamic dissolution condition; (D.) mass of the ingredient dissolved per unit linear distance of dissolution medium flow through a packed bed of a pressure-sensitive packed bed hydrodynamic dissolution condition; and (E.) another property of (a4.) equivalent to an algebraic transform of (a1.), wherein the algebraic transform comprises scaling by a factor chosen according to one or both of an in vivo dissolution condition and a simulative in vitro dissolution condition.

4. The method of claim 1, wherein the at least one property comprises a member selected from a subgroup consisting of property (a2.) hydraulic conductivity and the property of (a4.) equivalent to an algebraic transform of property (a2.), the property equivalent being a member selected from a group consisting of: (A.) specific hydraulic conductivity; (B.) specific hydraulic resistance; and (C.) another property of (a4.) equivalent to an algebraic transform of (a2.), wherein the algebraic transform comprises scaling by a factor chosen according to one or both of an in vivo dissolution condition and a simulative in vitro dissolution condition.

5. The method of claim 1, wherein the at least one property comprises a member selected from a subgroup consisting of property (a3.) vertical velocity of fluidization and the property of (a4.) equivalent to an algebraic transform of property (a3.).

6. The method of claim 1, wherein the at least one property comprising a member selected from a subgroup consisting of property (a5.) AUrMC and property (a6.) a property equivalent, the property equivalent being a member selected from a group consisting of: (A.) mean differential rate over mass; (B.) mean differential time over mass; and (C.) another property of (a4.) equivalent to an algebraic transform of (a5.), wherein the algebraic transform comprises scaling by a factor chosen according to one or both of an in vivo dissolution condition and a simulative in vitro dissolution condition.

7. The method of claim 1, wherein the at least one property comprising a member selected from a subgroup consisting of property (a1.) differential rate of dissolution, property (a2.) hydraulic conductivity, property (a3.) vertical velocity of fluidization, and property (a4.) a property equivalent, the evaluating comprises comparing value of a said at least one property, or a mathematical transform of the value, with value or range of values of a corresponding predetermined target of the said at least one property, or of the mathematical transform, respectively, in one or more manners selected from a group consisting of: (a11.) continuously over a range of continuous value of the cumulative mass of the ingredient dissolved; (a12.) discretely at each of a plurality of discrete values of the cumulative mass; and (a13.) discretely over each of a plurality of discrete ranges of values of the cumulative mass.

8. The method of claim 1, wherein the at least one property comprising a member selected from a subgroup consisting of property (a1.) differential rate of dissolution and the property of (a4.) equivalent to a linear scaling of property (a1.), the selected member being determined under at least two different dissolution conditions, the evaluating comprises computing a linear combination of values of the selected member obtained under the at least two different dissolution conditions, said linear combination being computed in one or more manners selected from a group consisting of: (a11.) continuously over a range of continuous value of the cumulative mass of the ingredient dissolved; (a12.) discretely at each of a plurality of discrete values of the cumulative mass; and (a13.) discretely over each of a plurality of discrete ranges of values of the cumulative mass.

9. The method of claim 1, wherein the at least one property comprising a member selected from a subgroup consisting of property (a1.) differential rate of dissolution and the property of (a4.) equivalent to an algebraic transform of property (a1.), the given dissolution condition is a member selected from a group consisting of: (A.) discrete fluidization and settlement hydrodynamic dissolution condition of a given linear vertical distance of local dissolution medium flow per unit time; (B.) pressure sensitive packed bed hydrodynamic dissolution condition under a given head pressure; (C.) dissolution condition repetitively occurring in first named periods throughout an in vitro dissolution process, among periods of another or other dissolution conditions different from dissolution condition of the first named periods; and (D.) cyclic dissolution condition of an in vitro dissolution process each cycle thereof consisting of a time-series of dissolution conditions each thereof simulating a component dissolution condition of an in vivo dissolution process for a relative duration to length of cycle reflecting probability of occurrence of the component dissolution condition at a point of time in the in vivo dissolution process equal to a point of time of the cycle in the in vitro dissolution process.

10. The method of claim 1, wherein the at least one property comprises a member selected from a subgroup consisting of property (a7.), property (a8.), and property (a9.).

11. The method of claim 1, wherein the manufacturing decision is a member selected from a group consisting of:
based on whether a said at least one property meets a predetermined target,
(b1.) acceptance or rejection of a production batch or lot of the solid dosage product; and
(b2.) acceptance or rejection of a formulation or production process of the solid dosage product; and
in a case where a said at least one property fails to meet a predetermined target,
(b3.) change, modification, or adjustment of variables of formulation and/or production process to effect a change in the said at least one property so that the said at least one property meets the predetermined target or the predetermined quality control specification.

12. A method of testing a solid dosage product to ensure desired or controlled rate of dissolution of an ingredient thereof in an in vivo dissolution environment, the in vivo dissolution environment comprising an in vivo dissolution medium and a complex in vivo hydrodynamic dissolution condition, the method comprising a step of determining and evaluating at least one property selected from a group consisting of:
as a function of, at least, cumulative mass of the ingredient dissolved from a sample of the solid dosage product,
(a1.) differential rate of dissolution of the ingredient dissolving from the sample under a given dissolution condition;
(a2.) hydraulic conductivity of a particulate or bed of particulates of the sample in a dissolution medium representing or substantially simulating the in vivo dissolution medium;
(a3.) vertical velocity of fluidization of a particulate or particulates of the sample in the dissolution medium; and
(a4.) a property equivalent to an algebraic transform of a property selected from a group consisting of property (a1.), property (a2.), and property (a3.);
for the ingredient dissolving in a given dissolution process or under a given dissolution condition,
(a5.) AUrMC, as defined by equation (eq. 6); and
(a6.) a property equivalent to an algebraic transform of property (a6.); and
under a cyclic dissolution condition of an in vitro dissolution process each cycle thereof consisting of a time-series of dissolution conditions each thereof simulating a component dissolution condition of an in vivo dissolution process for a relative duration to length of cycle reflecting probability of occurrence of the component dissolution condition at a point of time in the in vivo dissolution process equal to a point of time of the cycle in the in vitro dissolution process,
(a7.) differential rate of dissolution of the ingredient as a function of the point of time of the cycle;
(a8.) cumulative mass of the ingredient dissolved as a function of the point of time; and
(a9.) a property equivalent to an algebraic transform of a property selected from a group consisting of property (a7.) and property (a8.).

13. The method of claim 12, wherein the at least one property comprising a member selected from a subgroup consisting of property (a1.) differential rate of dissolution, property (a2.) hydraulic conductivity, property (a3.) vertical velocity of fluidization, and property (a4.) a property equivalent, the determining of the selected member comprises independently determining value of the cumulative mass of the ingredient dissolved, or that equivalent to an algebraic transform thereof, at each point, or thereabout, of an in vitro dissolution process selected from one or more in vitro dissolution processes, for which point a value of the selected member is determined for constructing the selected member as the function of, at least, cumulative mass of the ingredient dissolved.

14. (canceled)

15. The method of claim 12, wherein the at least one property comprises a member selected from a subgroup consisting of property (a1.) differential rate of dissolution, property (a2.) hydraulic conductivity, property (a3.) vertical velocity of fluidization, and property (a4.) a property equivalent, as a function of either the cumulative mass of the ingredient dissolved or at least both the cumulative mass and an independently variable dissolution medium contact time.

16. The method of claim 12, wherein the at least one property comprises a member selected from a subgroup consisting of property (a5.), property (a6.), property (a7.), property (a8.), and property (a9.).

17. The method of claim 12, further comprises providing a dissolution testing cell for the determining of the at least one property, the dissolution testing cell comprising a cell cavity, at least one side opening thereto disposed on a side wall thereof, and preferably at least one end opening thereto disposed at or near one end thereof, a said side opening being a member selected from a group consisting of: (A.) tangential opening, disposed in an axially symmetrical section of the side wall, oriented to a given circular direction, and in fluid communication with a fluid connection port of the dissolution testing cell; and (B.) ring-shaped opening, fitted with a ring-shaped filter inner side thereof forming a part of the side wall, and outer side thereof being in fluid communication with a fluid connection port of the dissolution testing cell.

18. The method of claim 12, further comprises providing a dissolution testing apparatus for the determining of the at least one property, the dissolution testing apparatus comprising: (A.) first pump means driving a stream of dissolution medium at a controlled or programmed flow rate; (B.) second pump means withdrawing a sample from a liquid or driving a sample out of a liquid; (C.) cumulative vessel storing a solute dissolved in a dissolution medium exited from a dissolution testing cell during a dissolution test; (D.) sampling means providing a sample for detection of a solute dissolved in a dissolution medium; (E.) first switching valve means switching among at least two positions comprising first position and second position, the first position allowing a sample from the dissolution testing cell to travel to the sampling means via a fluid conduit, under aid from either one or both of the first and the second pump means, and the second position a sample from the cumulative vessel; and (F.) control means controlling at least the independent functioning of the first and the second pump means, and the functioning of the first switching valve means.

19. The method of claim 12, wherein the at least one property comprising a member selected from a group consisting of property (a1.) differential rate of dissolution and the property of (a4.) equivalent to an algebraic transform of property (a1.), the given dissolution condition is a member selected from a group consisting of: (A.) discrete fluidization and settlement hydrodynamic dissolution condition of a given linear vertical distance of local dissolution medium flow per unit time; (B.) pressure sensitive packed bed hydrodynamic dissolution condition under a given head pressure; (C.) dissolution condition repetitively occurring in first named periods throughout an in vitro dissolution process, among periods of another or other dissolution conditions different from dissolution condition of the first named periods; and (D.) cyclic dissolution condition of an in vitro dissolution process each cycle thereof consisting of a time-series of dissolution conditions each thereof simulating a component dissolution condition of an in vivo dissolution process for a relative duration to length of cycle reflecting probability of occurrence of the component dissolution condition at a point of time in the in vivo dissolution process equal to a point of time of the cycle in the in vitro dissolution process.

20. The dissolution testing cell of claim 17, wherein further the cell cavity comprises an axially symmetrical preferably cylindrical shape, the dissolution testing cell comprising the at least one end opening thereto comprising first end opening fitted with a large-area filter one side thereof providing a wall to the cell cavity and the other side thereof being in fluid communication with a fluid connection port of the dissolution testing cell, the at least one side opening thereto comprising at least one preferably two or three of member (A.) tangential opening disposed and equally spaced along a circularly shaped edge, or edge portion, of the large-area filter on side of the cell cavity, and a said tangential opening being preferably fitted with a filter or being a part of the large-area filter.

21. The dissolution testing cell of claim 17, comprising the at least one end opening thereto, wherein further the cell cavity comprises a first section having a known preferably constant further preferably a given circular cross-sectional area throughout, the at least one end opening comprising a bottom end opening fitted with a bottom filter top side thereof providing an end wall to bottom end of the first section, said dissolution testing cell comprising further a pair of side openings disposed on side wall of the first section, spaced apart one from another for a known distance along axial direction thereof, each fitted with a filter, and each providing an access point for one side of the diaphragm of a differential pressure transducer.

22. The dissolution testing cell of claim 17, wherein further the cell cavity is characterized by a generally cylindrical shape and a minimal axial dimension, the at least one side opening being at least one member (A.) tangential opening equally spaced one from any other along circular side wall of the cell cavity, the dissolution testing cell comprising the at least one end opening comprising a small dimension end opening centrally disposed on a top end wall of the cell cavity, a lower cell cavity for housing a sample, and a diffusion membrane separating the sample from the cell cavity, providing a porous bottom end wall to the cell cavity, and providing means for an ingredient dissolved from the sample to diffuse therethrough to the cell cavity.

23. The dissolution testing cell of claim 17, comprising the at least one end opening comprising an end opening disposed at a first end, and further an axially elongated preferably cylindrical shape of the cell cavity comprising preferably a tapered section and a nipple-shaped space at each of two ends thereof, the at least one side opening thereto comprising a pair of member (B.) ring-shaped openings disposed from said first end for a distance to provide a volume of cell cavity space over the distance to hold an undisturbed bed of sample while the cell is in one vertical orientation, and from a second end opposing the first end for a known distance to allow accurate measurement of time of settlement of a particulate settling from the second end in a dissolution medium when the vertical orientation is reversed; wherein, the pair of ring-shaped openings are adapted to provide a flow of dissolution medium across an analytical section of the cell cavity for detection of a dissolving particulate settling therethrough.

24. The dissolution testing apparatus of claim 18, wherein the (C.) cumulative vessel comprises a vessel cavity characterized by a one-turn spiral bottom wall and an axially symmetrical preferably a reversed truncated cone-shaped side wall.

25. The dissolution testing apparatus of claim 18, further comprising (G.) second switching valve means switching, under control of the (F.) control means, destination of the stream from the (A.) first pump means among at least two destinations each consisting of a member or a combination of members selected from a group consisting of different fluid connection ports of the dissolution testing cell, carrier fluid inlet of a flow injection analysis sampling valve, and a fluid connection port of the (E.) first switching valve means.

26. The dissolution testing apparatus of claim 18, wherein the (E.) first switching valve means comprises a multi-port rotary switching valve comprising: first port, connected to the (D.) sampling means via a fluid conduit; second port, shorted to a third port; fourth port, for connection to a fluid connection port of the dissolution testing cell; fifth port, connected to the (C.) cumulative vessel; and sixth port, the (B.) second pump means; wherein, the multi-port rotary switching valve: in the first position of the first switching valve means, internally connects the first port to the second, the third to the fourth, and the fifth to the sixth; and in the second position of the first switching valve means, the second port to the third, the fourth to the fifth, and the sixth to the first.

27. The dissolution testing apparatus of claim 18, wherein the (E.) first switching valve means comprises a multi-port rotary switching valve comprising: first port, connected to the (A.) first pump means via a fluid conduit; second port, for connection to a first fluid connection port of the dissolution testing cell; third port, a second fluid connection port thereof; fourth port, connected to the (D.) sampling means; fifth port, for connection to a third fluid connection port of the dissolution testing cell; and sixth port, a fourth fluid connection port thereof; wherein, the multi-port rotary switching valve: in the first position of the first switching valve means, internally connects the first port to the sixth, the third to the fourth, while closing off the fifth and the sixth; and in the second position of the first switching valve means, connects the second port to the third, the fifth to the sixth, while closing off the first and the fourth.

28. The dissolution testing apparatus of claim 18, further comprising vertical orientation means for switching vertical orientation of cell cavity of the dissolution testing cell between, and alternately maintaining each of, two opposite orientations during a dissolution test.

29. The dissolution testing apparatus of claim 18, wherein the (D.) sampling means further comprises a multi-stream sampling valve switching among a sampling position and a plurality of analyzing positions, the multi-stream sampling valve comprising: a rotor; a stator; a plurality of sample loops; a fluid distribution channel, defined between the rotor and a top plate of the stator; through-holes formed through, and grooves formed into bottom of, a rotor plate of the rotor; wherein, when the valve is in the sampling position, a set of the through-holes and grooves of the rotor plate connects an incoming carrier fluid directly to a common fluid exit of the valve, each of a plurality of other sets of the through-holes and grooves connects a corresponding incoming sample fluid stream to a corresponding sample stream exit of the valve via a corresponding sample loop, and, when the valve is switched to a said analyzing position, the carrier fluid is rerouted through the sample loop corresponding to the said analyzing position via the fluid distribution channel, carrying content of the sample loop to the common fluid exit.

30. The dissolution testing apparatus of claim 18, further comprising a differential pressure transducer, each of two sides of a diaphragm thereof being adapted to connection to a different fluid connection port of the dissolution testing cell.

31. The dissolution testing cell of claim 20, comprising the preferred cylindrical shape of the cell cavity, the cell cavity further comprises a tapered end section at each of two ends thereof.

32. The dissolution testing cell of claim 21, wherein further the first section having the constant circular cross-sectional area throughout, the cell cavity comprises a second section of a reversed truncated cone shape disposed on top of the first section immediately above the pair of side openings thereof, and a third section of a generally cylindrical shape disposed on top of the second section, bottom end of the second section communicating with top end of the first, and of the third section the second, the at least one side opening further comprising a member (B.) ring-shaped opening disposed immediately above said pair of side openings, inner side of the ring-shaped filter of the ring-shaped opening forming at least a part of side wall defining the second section and preferably having a large surface area.

33. A method of processing dissolution testing data, comprising steps of: (a.) receiving, or receiving and computing, determined time profile data of a dissolution property; and (b.) constructing in accordance with the determined time profile data a function of the dissolution property, or an algebraic transform thereof, versus cumulative mass of an ingredient dissolved, or an algebraic transform thereof.

34. The dissolution testing apparatus of claim 18, wherein the (E.) first switching valve means comprises a multi-port selection valve comprising: a common port, connected to the (D.) sampling means via a fluid conduit; and at least two selection ports, one connected to the (C.) cumulative vessel, and at least one for connection to the dissolution testing cell; and wherein further, the (B.) second pump means comprises either one or both members selected from a group consisting of (B1.) a syringe pump and (B2.) a pneumatic pump, the pneumatic pump comprising a valve-controlled source of pressurized inert gas connected to either one or both of the dissolution testing cell and the cumulative vessel, gas-tight.
